(19) United States
(12) Patent Application Publication
(10) Pub. No.: US 2015/0042134 A1
(43) Pub. Date: Feb. 12, 2015

(54) VEHICLE SEAT

(71) Applicant: TS TECH CO., LTD., Asaka-shi, Saitama (JP)

(72) Inventors: Shuichi Shimizu, Shioya-gun (JP); Yuichiro Seki, Shioya-gun (JP); Shinji Sugiyama, Shioya-gun (JP); Kazunori Ishihara, Shioya-gun (JP)

(21) Appl. No.: 14/384,118

(22) PCT Filed: Mar. 5, 2013
(86) PCT No.: PCT/JP2013/055986

§ 371 Date: Sep. 9, 2014

(30) Foreign Application Priority Data
Mar. 14, 2012 (JP) 2012-057996
Mar. 14, 2012 (JP) 2012-057997
Mar. 19, 2012 (JP) 2012-062526

(51) Int. Cl. B60N 2/42

(52) U.S. Cl. CPC B60N 2/4228
USPC 297/216.14

(57) ABSTRACT

In a vehicle seat including a seat cushion and a seat back, the seat back includes: a seat back frame F2 comprising right and left side frames 20 constituting right and left frames of the seat back; a pressure-receiving portion 41 located between the right and left side frames 20 at a rear of an occupant and configured to be movable rearward relative to the right and left side frames 20; and support portions 42 extending laterally outward from right and left end portions of the pressure-receiving portion 41 and configured to support side portions of an upper body of the occupant in the seat back.

### TECHNICAL FIELD

The present invention relates to a vehicle seat comprising a seat cushion and a seat back.

### BACKGROUND ART

Conventionally, there is known a vehicle seat including a pressure-receiving member (pressure-receiving portion) located between right and left side frames at the rear of an occupant and configured to be movable rearward relative to the right and left side frames (see Patent Literature 1). This pressure-receiving portion supports the upper body of the occupant from the rear side via a cushion material when the occupant is in a normal seating condition; when the upper body of the occupant moves backward in a rear-end collision, the pressure-receiving portion is pressed by the upper body of the occupant and moves rearward to thereby allow the upper body of the occupant to sink into the seat back. The head of the occupant approaches and thus gets received by the headrest as the upper body of the occupant sinks into the seat back, so that an impact applied to the neck of the occupant in the rear-end collision can be reduced.

### CITATION LIST

### Patent Literature

Patent Literature 1: Japanese Laid-open Patent Application, Publication No. 2010-83268

### SUMMARY OF THE INVENTION

Even if a seat is configured to allow the upper body of the occupant to sink into the seat back in a rear-end collision, it is of course required that the seat can stably support the upper body of the occupant in the normal seating condition.

In view of the above, the present invention seeks to provide a vehicle seat which can stably support the upper body of the occupant in the normal seating condition.

To achieve the above object, a vehicle seat according to the present invention comprises a seat cushion and a seat back, wherein the seat back includes: a seat back frame comprising right and left side frames constituting right and left frames of the seat back; a pressure-receiving portion located between the right and left side frames at a rear of an occupant and configured to be movable rearward relative to the right and left side frames; and support portions extending laterally outward from right and left end portions of the pressure-receiving portion and configured to support side portions of an upper body of the occupant in the seat back.

With this configuration, the pressure-receiving portion can support the upper body of the occupant from the rear side while the support portions can support the upper body of the occupant from both sides; therefore, in the normal seating condition, the upper body of the occupant can be stably supported.

In the above vehicle seat, the support portions may extend frontward relative to the pressure-receiving portion.

With this configuration, since the support portions extend frontward relative to the pressure-receiving portion, the pad material can be made with smaller thickness at positions between the support portions and the occupant. Accordingly, as compared to the configuration in which the pad material is thicker, the side portions of the upper body of the occupant in the normal seating condition can be more stably supported by the support portions. Further, the pad material is more easily deformable with the thus-reduced thickness of the pad material; therefore, the upper body of the occupant can be caused to quickly and deeply sink into the seat back in the rear-end collision. As a result, the head of the occupant quickly approaches and gets received by the headrest, so that an impact applied to the neck of the occupant can be further reduced.

If the thickness of the pad material is thick at positions between the support portions and the occupant, the upper body of the occupant is less likely to sink into the seat back; however, since the aforementioned configuration makes the pad material thinner, the upper body of the occupant can be caused to quickly and deeply sink into the seat back.

In each of the above vehicle seats, the support portions may be provided at positions at least corresponding to a height of a lumbar region of the occupant.

With this configuration, the support portions can stably support the lumbar region of the occupant in the normal seating condition to thereby stabilize the seating posture of the occupant. Further, if the support portions are configured to extend frontward relative to the pressure-receiving portion, the thickness of the pad material at the lumbar region can be reduced; therefore, the lumbar region of the occupant can be caused to quickly and deeply sink into the seat back in the rear-end collision.

In each of the above vehicle seats, the support portions may be integrally formed with the pressure-receiving portion.

With this configuration, as compared to the configuration in which the support portions and the pressure-receiving portion are formed as discrete parts, the structure of the vehicle seat can be simplified while preventing the number of parts from being increased. Further, if the support portions are configured to extend frontward relative to the pressure-receiving portion, the rigidities of the support portions and the pressure-receiving portion are enhanced, so that the upper body of the occupant can be more stably supported.

If the support portions and the pressure-receiving portion are formed as discrete parts, the structure of the vehicle seat may possibly be complicated and the number of parts will disadvantageously be increased; however, these problems can be solved by the above-described configuration.

The above vehicle seat in which the above-described support portions are provided at positions corresponding to the height of the lumbar region of the occupant may further comprise a first connecting wire extending laterally and configured to connect the pressure-receiving portion with the right and left side frames, and the first connecting wire may be disposed at a position corresponding to the height of the lumbar region of the occupant, passing through rear sides of the support portions.

With this configuration, since the first connecting wire passes through rear sides of the support portions which are provided at positions corresponding to the height of the lumbar region of the occupant, a load applied to the support portions can also be supported by the first connecting wire. Therefore, the upper body (lumbar region) of the occupant can be more stably supported.

In the above vehicle seat, the first connecting wire may have bent portions protruding in at least one of upper and lower directions at rear sides of the support portions.

With this configuration, since the first connecting wire disposed at the rear of the support portions runs in an increased area, the load applied to the support portions can be stably supported by the first connecting wire. Therefore, the upper body (lumbar region) of the occupant can be much more stably supported.

In each of the above vehicle seats, the support portions may be provided at positions corresponding to a height of a lumbar region of the occupant and a height of a chest region of the occupant.

With this configuration, as compared to the configuration in which the support portions are provided only at positions corresponding to the height of the lumbar region of the occupant or at positions corresponding to the height of the chest region of the occupant, the support portions have increased areas; therefore, in the normal seating condition, the side portions of the upper body of the occupant can be more stably supported by the support portions. Further, if the support portions are configured to extend frontward relative to the pressure-receiving portion, the thickness of the pad material can be reduced at the lumbar region and at the chest region; therefore, the entire upper body of the occupant can be caused to quickly and deeply sink into the seat back in the rear-end collision.

The above vehicle seat may further comprise a second connecting wire extending laterally and configured to connect the pressure-receiving portion with the right and left side frames, and the second connecting wire may be disposed at a position corresponding to the height of the chest region of the occupant, passing through rear sides of the support portions.

With this configuration, since the second connecting wire passes through rear sides of the support portions which are provided at the position corresponding to the height of the chest region of the occupant, a load applied to the support portions can also be supported by the second connecting wire. Therefore, the upper body (chest region) of the occupant can be more stably supported.

In the above vehicle seat, the second connecting wire may have bent portions protruding in at least one of upper and lower directions at rear sides of the support portions.

With this configuration, since the second connecting wire disposed at the rear of the support portions runs in an increased area, the load applied to the support portions can be stably supported by the second connecting wire. Therefore, the upper body (chest region) of the occupant can be much more stably supported.

In the vehicle seat in which the above-described support portions are provided at positions corresponding to the height of the lumbar region of the occupant and at the position corresponding to the height of the chest region of the occupant, the support portions provided at the positions corresponding to the height of the lumbar region of the occupant and the support portions provided above said support portions at the positions corresponding to the height of the chest region of the occupant may be joined together.

With this configuration, as compared to the configuration in which the support portions provided at the positions corresponding to the height of the lumbar region of the occupant and the support portions provided at the positions corresponding to the height of the chest region of the occupant are separately provided, the support portions have increased areas; therefore, in the normal seating condition, the side portions of the upper body of the occupant can be more stably supported by the support portions.

In the above vehicle seat, the pressure-receiving portion may comprise reinforcement beads.

With this configuration, since the rigidity of the pressure-receiving portion is enhanced, the upper body of the occupant can be more stably supported by the pressure-receiving portion.

The above vehicle seat may be configured such that when a backward movement load is not applied from the upper body of the occupant to the seat back, laterally outermost portions of the second connecting wire are located outward of the support portions.

In a second aspect of the present invention, the above-described vehicle seat according to the present invention is configured such that the pressure-receiving portion and the support portions are formed as discrete parts.

With this configuration, since the pressure-receiving portion and the support portions are formed as discrete parts, they can be manufactured separately; therefore, as compared to the configuration in which the pressure-receiving portion and the support portions are manufactured together as an integral part, design variations of the pressure-receiving portion and the support portions such as manufacturable size and shape can be increased. Accordingly, the degree of flexibility in designing the pressure-receiving portion and the support portions can be improved.

In the above vehicle seat, the support portions may be configured to be detachable from the pressure-receiving portion.

With this configuration, since the support portions can be detached from and attached to the pressure-receiving portion, the support portions are replaceable. Therefore, for example, replacement and/or reuse of the support portions can be accomplished.

If the support portions are fixed to the pressure-receiving portion, for example, by adhesive, the possibility of replacing the support portions and reusing the support portions only may be remote; however, this problem can be solved by the above-described configuration.

In the above vehicle seat, each of the support portions may comprise: a plate-like support portion main body configured to support a side portion of the upper body of the occupant; an engagement claw extending from the support portion main body toward the pressure-receiving portion and configured to be engageable with an engagement hole formed in each of right and left ends of the pressure-receiving portion; and a bead provided on the support portion main body and extending in a direction in which the engagement claw extends. Further, in place of the beads, a wire may be embedded in the support portion main body.

With this configuration, each of the support portions can be readily attached to the pressure-receiving portion by means of engagement between the engagement claw of the support portion and the engagement hole of the pressure-receiving portion. Further, since the rigidity of the support portion can be improved by providing the bead on the support portion main body or the wire in the support portion main body, the side portions of the upper body of the occupant can be more stably supported by the support portions.

If the support portions are fastened to the pressure-receiving portion, for example, using bolts and nuts, the attachment of the support portions may possibly be time-consuming; however, this problem can be solved by the above-described configuration. Further, if the support portion main body takes a flat plate-like shape, the support portion main body is easily deformable and thus difficult to provide a stable support; however, this problem can be solved by the above-described configuration.

In the above vehicle seat, each of the support portions may comprise a restriction portion extending from the support portion main body toward the pressure-receiving portion, the restriction portion being configured to extend along a rear surface of the pressure-receiving portion to a rear side of one of the right and left ends of the pressure-receiving portion to thereby restrict a rearward movement of the support portion.

With this configuration, since the restriction portion can restrict the rearward movement of the support portion, the side portions of the upper body of the occupant can be stably supported by the support portions. Further, restricting the rearward movement of the support portion makes it possible to prevent the engagement claw (support portion) from coming off the engagement hole (pressure-receiving portion).

If each support portion is allowed to rotate largely in the rearward direction, it may be difficult to provide a stable support; however, this problem can be solved by the above-described configuration. Further, if the support portions are largely rotatable in the rearward direction, the support portions may disadvantageously come off the pressure-receiving portion; however, this problem can be solved by the above-described configuration.

In each of the above vehicle seats, the support portions may be thicker in thickness than the pressure-receiving portion.

With this configuration, since the rigidity of the support portions can be improved, the side portions of the upper body of the occupant can be stably supported by the support portions.

If the thickness of the support portions is thinner than that of the pressure-receiving portion, it may be difficult to provide a stable support; however, a stable support can be provided by the above-described configuration.

Each of the above vehicle seats may further comprise a connecting wire extending laterally and configured to connect the pressure-receiving portion with the right and left side frames, and the connecting wire may be so disposed as to avoid joint portions of the pressure-receiving portion and the support portions, passing through rear sides of the pressure-receiving portion and the support portions. To be more specific, for example, in the configuration in which the pressure-receiving portion and the support portions include at least two connecting portions which are arranged one above another, at each of right and left sides of the pressure-receiving portion, the connecting wire may have straight portions each extending laterally, and each of the straight portions may be disposed between the two connecting portions which are arranged one above another.

With this configuration, interference between the connecting wire and the joint portions of the pressure-receiving portion and the support portions can be prevented. Accordingly, for example, in the configuration in which the support portions have engaging portions engaged with the pressure-receiving portion and the engaging portions protrude rearward from the pressure-receiving portion, the protruding portions of the engaging portions (joint portions) would not be pushed frontward by the connecting wire; this configuration makes it possible to prevent the support portions from coming off the pressure-receiving portion. Further, since the connecting wire passes through the rear sides of the support portions, the connecting wire can also support a load applied to the support portions, with the result that the side portions of the upper body of the occupant can be stably supported.

If the connecting wire is disposed to pass through the joint portions, the connecting wire may push the joint portions, so that the support portions may possibly come off the pressure-receiving portion; however, this problem can be solved by the above-described configuration. Further, if the support portions and the connecting wire are arranged at positions offsetting from each other in the upper-lower direction, the connecting wire is less likely to contribute to the support of the occupant; however, the above-described configuration makes effective use of the connecting wire for supporting the occupant.

In the above vehicle seat provided with the aforementioned connecting wire, the connecting wire may have bent portions protruding in at least one of upper and lower directions at the rear sides of the support portions.

With this configuration, since the connecting wire disposed at the rear of the support portions is laid in an increased area, the load applied to the support portions can be stably supported by the connecting wire. Therefore, the side portions of the upper body of the occupant can be more stably supported.

In each of the above vehicle seats, joint portions which join the pressure-receiving portion with the support portions may be located laterally inside the right and left side frames.

With this configuration, interference between the joint portions and the side frames can be prevented. This configuration prevents, for example, an undesirable load from being applied to the joint portions, so that it is possible to prevent the support portions from coming off the pressure-receiving portion.

If the joint portions and the side frames laterally overlap each other, the joint portions may hit the side frames and the support portions may come off the pressure-receiving portion; however, this problem can be solved by the above-described configuration.

According to another aspect of the present invention, it is a further object of the present invention to suppress interference between the pressure-receiving member and surrounding parts.

In a third aspect of the present invention, the above-described vehicle seat according to the present invention may further comprise a seat back pad covering the seat back frame, and the vehicle seat may be configured such that a pressure-receiving member consisting of the pressure-receiving portion and the support portions is supported by the seat back frame in such a manner that when a backward movement load is applied from the upper body of the occupant to the seat back, the upper body of the occupant is allowed to sink into the seat back, that the seat back pad comprises a center portion configured to face a back region of the upper body of the occupant, and right and left side portions provided at right and left sides of the center portion and each configured to protrude frontward farther than the center portion, that the pressure-receiving member is located in the seat back at a position corresponding to the center portion, and the pressure-receiving portion is connected to the right and left side frames via a connecting member, and that the support portions are disposed at rear sides of the side portions, and an upper edge of each of the support portions is lower than an upper edge of the pressure-receiving portion.

With this configuration, the pressure-receiving member includes not only the pressure-receiving portion disposed at the rear of the center portion of the seat back pad but also the support portions extending laterally outward and frontward from the both lateral end portions of the pressure-receiving portion and disposed at the rear of the side portions of the seat back pad; therefore, when a backward movement load generates, the load is applied from the seat back pad to both the pressure-receiving portion and the support portions, so that the load is quickly transmitted by the pressure-receiving member, with the result that the occupant can be caused to quickly sink into the seat back. Especially, if a rear-end collision occurs when the occupant is seated improperly or when the vehicle runs on a sloping road or turns a corner, the load applied from the occupant to the seat may possibly deviate a little in the lateral direction; however, even in this case, the load from the occupant can be efficiently received by this configuration and the occupant can be caused to quickly sink into the seat back.

Further, in this vehicle seat, since the upper edge of each of the support portions is lower than the upper edge of the pressure-receiving portion, the occupant is less likely to experience an uncomfortable contact feeling at the upper corner portions of the support portions and thus a comfortable seating feeling can be provided, as compared to the configuration in which the upper edge of the pressure-receiving portion and the upper edges of the support portion extend to the same height. Further, the seat back pad of a normal-type vehicle seat (not a sport type vehicle seat) does not protrude laterally frontward as far as the sport type vehicle seat does, and if the support portions extend upward to the proximity of the upper edge of the pressure-receiving portion, undesirable interference may occur between the support portions and the seat back pad; however, since this vehicle seat is configured such that the upper edge of each of the support portions is lower than the upper edge of the pressure-receiving portion, it is possible to suppress undesirable interference between the support portions and the seat back pad.

In the above vehicle seat, a stepped portion may be provided between the upper edge of each of the support portions and the upper edge of the pressure-receiving portion.

With this configuration, the support portions are easily deformable at proximal portions where the support portions extend from the pressure-receiving portion, so that a soft seating feeling can be obtained.

In the above vehicle seat, a reinforcement portion may be provided at the upper edge of each of the support portions.

In this description, that portion of each of the support portions whose upper edge is lower than the upper edge of the pressure-receiving portion is referred to as a “relief portion” as a matter of convenience; the rigidity of the support portion slightly decreases due to the relief portion formed in the support portion. However, according to the above-described configuration, since the reinforcement portion is provided at the upper edge, it is possible to compensate the rigidity of the support portion reduced due to formation of the relief portion. Therefore, this configuration can provide a firm support feeling to a sport type vehicle seat and the like.

In the above vehicle seat, each of the support portions may include a bead portion which protrudes rearward, and the bead portion may extend obliquely in a laterally outward and upward direction.

With this configuration, it is possible to compensate the rigidity of the support portion reduced due to formation of the relief portion in the support portion by means of the bead portion, so that a firm support feeling can be provided to a sport type vehicle seat and the like.

In the above vehicle seat including the bead portion, each of the support portions may have an edge, and a reinforcement portion may be provided at least at an upper portion of the edge of the support portion, and further the bead portion may extend to the reinforcement portion.

With this configuration, the rigidity of the support portion is further enhanced, and the vehicle seat can provide a firm support feeling.

In each of the above vehicle seats, the connecting member may pass through rear sides of the support portions.

With this configuration, since a backward load is applied from the support portions to the connecting member when the support portions are pressed rearward, the occupant can be caused to more quickly sink into the seat back in a rear-end collision.

In the above vehicle seat, each of the support portions may include an engagement hook engageable with the connecting member.

With this configuration, the connecting member and the support portions are held together and less likely to be shifted from each other; therefore, abnormal noise resulting from vibration is not likely to occur, and if a large load is applied to the support portion, the load can be efficiently transmitted from the support portion to the connecting member.

Preferably, the above vehicle seat may further comprise a fixing member for fixing an air bag device to one of the side frames, and the fixing member may be disposed at a position higher than a lowest end of the upper edge of each of the support portions.

With this configuration, it is possible to prevent a fixing member for fixing the air bag device, such as a bolt, from interfering with the support portion.

### BRIEF DESCRIPTION OF DRAWINGS

FIG. 1 is a perspective view of a car seat as a vehicle seat according to a first embodiment.

FIG. 2 is a perspective view of a seat frame embedded in the car seat.

FIG. 3 is a front view of a seat back frame constituting the seat frame.

FIG. 4 is a sectional view taken along the line IV-IV of FIG. 3.

FIG. 5 is a perspective view of a pressure-receiving member disposed in the seat back frame.

FIG. 6 includes sectional views of the seat back when a backward movement load acts on the seat back, in which (a) shows an embodiment in which support portions are formed in the pressure-receiving member, and (b) shows a comparative example in which the support portions are not formed in the pressure-receiving member.

FIG. 7 is a perspective view of the pressure-receiving member according to a modified embodiment.

FIG. 8 is a perspective view of the seat frame embedded in a car seat according to a second embodiment.

FIG. 9 is a top view of the seat back frame constituting the seat frame.

FIG. 10 includes perspective views of a pressure-receiving portion and a support portion, in which (a) shows a view before attachment of the support portion, and (b) shows a view after the support portion is attached.

FIG. 11 is a sectional view taken along the line XI-XI of FIG. 9.

FIG. 12 is a sectional view taken along the line XII-XII of FIG. 9.

FIG. 13 includes sectional views of the seat back when a backward movement load acts on the seat back, in which (a) shows portions corresponding to a height of a chest region of an occupant, and (b) shows portions corresponding to a height of a lumbar region of an occupant.

FIG. 14 is a sectional view similar to FIG. 11, but shows a car seat according to a modified embodiment.

FIG. 15 is a perspective view showing a car seat according to another modified embodiment, in which wires are embedded in the support portion.

FIG. 16 is a perspective view of a car seat as a vehicle seat according to a third embodiment.

FIG. 17 is a perspective view of the seat frame embedded in the car seat.

FIG. 18 is a rear view of the pressure-receiving member.

FIG. 19 is a vertical section showing the side portion of a seat back pad and the support portion.

FIG. 20 is a rear view of the pressure-receiving member according to a first modified embodiment.

FIG. 21 is a rear view of the pressure-receiving member according to a second modified embodiment.

FIG. 22 is a rear view of the pressure-receiving member according to a third modified embodiment.

FIG. 23 is a perspective view of the pressure-receiving member according to a fourth modified embodiment, as viewed from the rear side.

FIG. 24 is a perspective view of the pressure-receiving member according to a fifth embodiment, as viewed from the rear side.

### DESCRIPTION OF EMBODIMENTS

One embodiment of the present invention will be described in detail with reference to the drawings, where necessary.

### First Embodiment

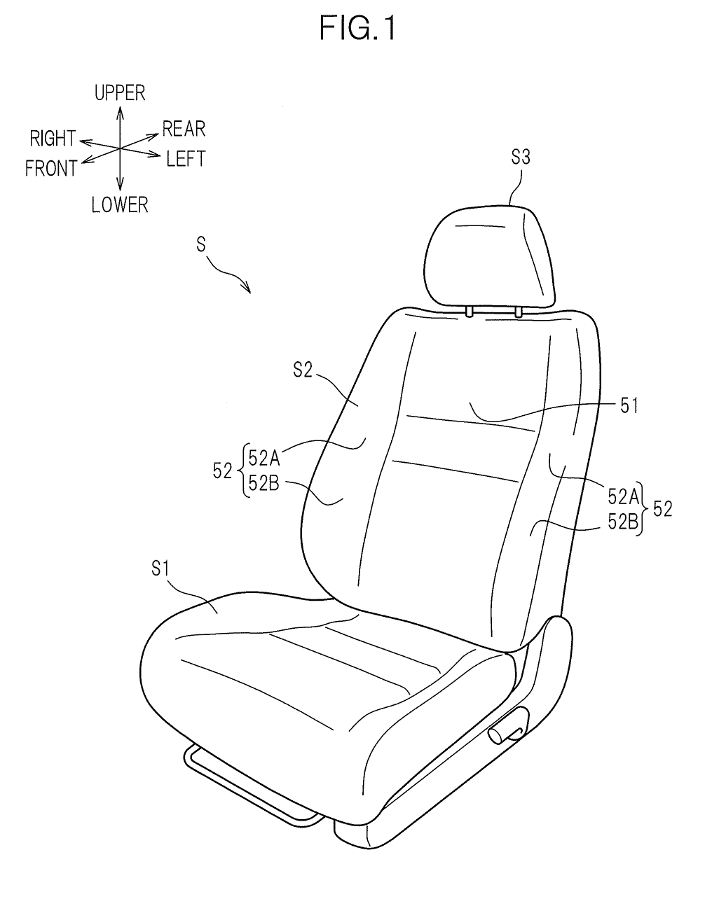

With reference to FIGS. 1 to 7, one embodiment of the present invention and modified embodiments thereof will be described.

As seen in FIG. 1, a vehicle seat according to one embodiment of the present invention is configured as a car seat S used for a driver's seat of a car, and mainly includes a seat cushion S1 on which an occupant sits, a seat back S2 as a backrest, and a headrest S3. As will hereinafter be described in detail, the car seat S is configured such that the upper body of the occupant sinks into the seat back S2 when the car is rear-ended by another car or when the car collides at its rear portion with another car or a structural object while reversing, and a backward movement load acts on the seat back S2 from the upper body of the occupant.

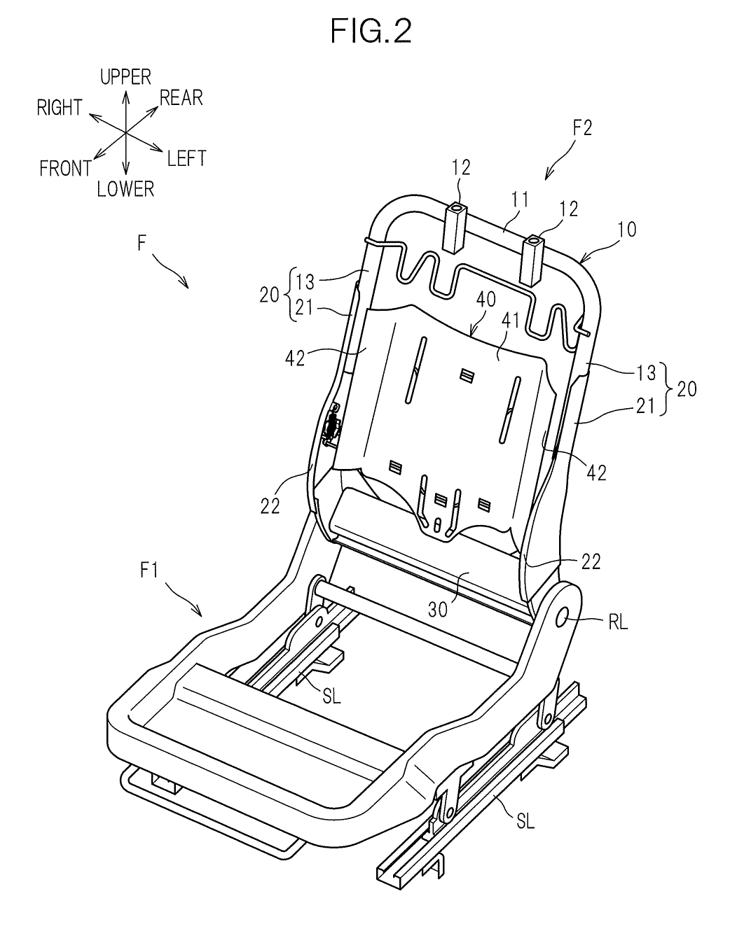

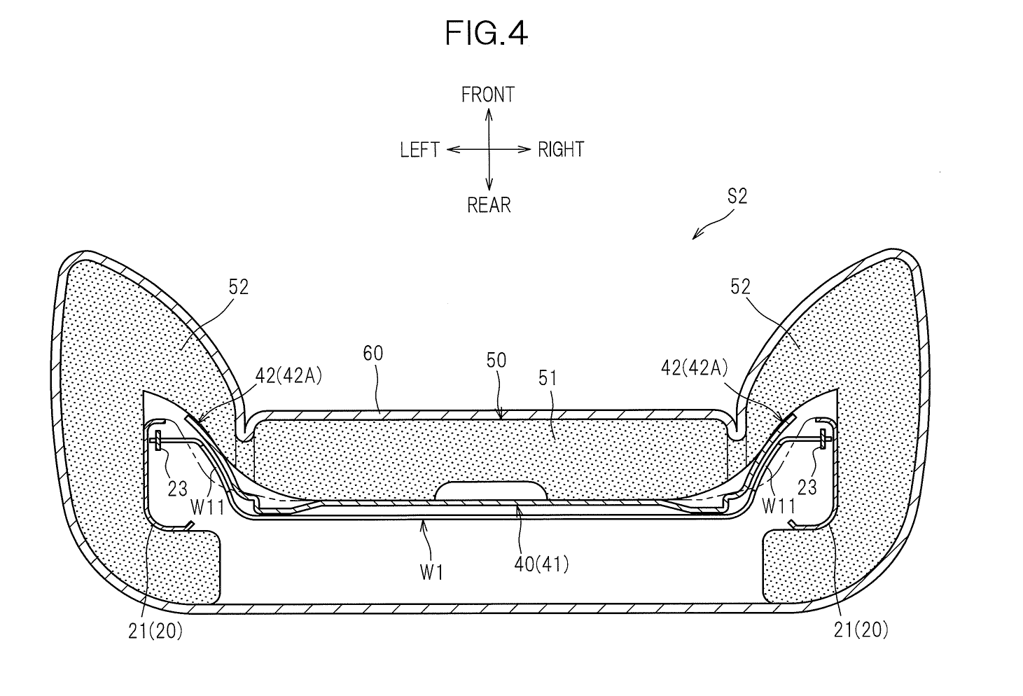

A seat frame F as shown in FIG. 2 is embedded in the seat cushion S1 and the seat back S2. The seat frame F mainly includes a seat cushion frame F1 constituting a frame of the seat cushion S1, and a seat back frame F2 constituting a frame of the seat back S2. The seat cushion S1 is configured such that the seat cushion frame F1 is covered with a seat cushion pad made of a cushion material such as urethane foam, and a skin material made of synthetic leather or fabric. The seat back S2 is configured such that the seat back frame F2 is covered with a seat back pad 50 made of a cushion material, and a skin material 60 (see FIG. 4).

The seat cushion frame F1 is installed on a floor of the car via slide rails SL in such a manner as to be slidable in the front-rear directions. Further, a lower portion of the seat back frame F2 is connected to a rear portion of the seat cushion frame F1 via a reclining mechanism RL in such a manner as to be tiltable in the front-rear directions.

In this description, the front/back (frontward/rearward), right/left (lateral), and upper/lower directions are designated as from the view point of an occupant seated on the car seat S of which the seat back S2 is not tilted down by the reclining mechanism RL.

The seat back frame F2 mainly consists of an upper frame 10, right and left side frames 20, and a lower frame 30; the upper frame 10, the right and left side frames 20, and the lower frame 30 are joined together, for example, by welding to thereby form a frame-like configuration. A pressure-receiving member 40 is disposed between the right and left side frames 20; the pressure-receiving member 40 is configured to support the upper body of the occupant so as to be movable in the rearward direction.

The upper frame 10 is formed by bending a pipe material into a substantially U-shape configuration and includes a lateral pipe portion 11 extending in the right-left direction, and a pair of right and left support brackets 12 for attachment of the headrest S3 are fixed by welding to the front side of the lateral pipe portion 11. Right and left vertical pipe portions 13 of the upper frame 10 extend in the upper-lower direction; right and left side frame main body portions 21 are joined to lower portions of the vertical pipe portions 13 and made into integral parts to thereby form right and left frames (right and left side frames 20) of the seat back S2.

Each of the right and left side frame main body portions 21 is made by press working sheet metal to have a substantially U-shaped cross section; the side frame main body portions 21 are arranged laterally opposite to each other. The side frame main body portion 21 is connected to the vertical pipe portion 13 with its upper portion holding the vertical pipe portion 13, and the lower portion of the side frame main body portion 21 protrudes frontward farther than the upper portion of the side frame main body portion 21 to form a bulging portion 22.

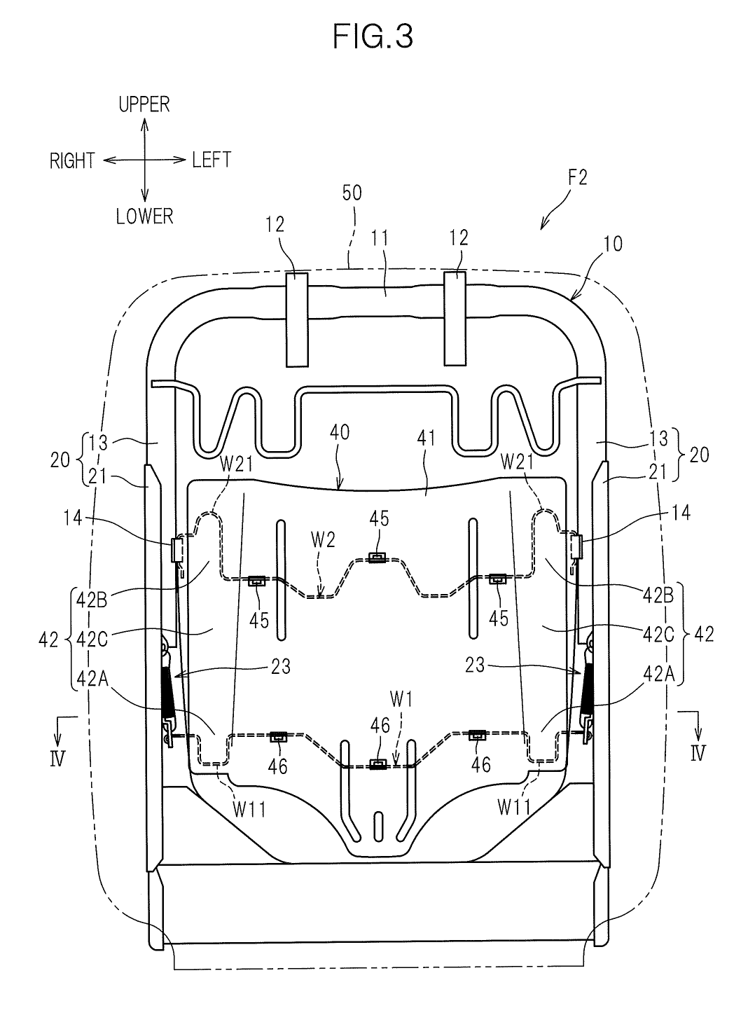

The pressure-receiving member 40 is a plate-like member, for example, made of plastic resin, and as seen in FIG. 3, the pressure-receiving member 40 is provided to be movable in the rearward direction relative to the right and left side frames 20, via a lower connecting wire W1 (as an example of a first connecting wire) and an upper connecting wire W2 (as an example of a second connecting wire) extending substantially in the right-left direction. To be more specific, the upper connecting wire W2 is engaged with engagement portions 45 formed at an upper portion of the back side of the pressure-receiving member 40, and each of right and left end portions of the upper connecting wire W2 is engaged with a supporting tab 14 fixed to the vertical pipe portion 13, so that the upper portion of the pressure-receiving member 40 is connected to the right and left side frames 20. The lower connecting wire W1 is engaged with engagement portions 46 formed at a lower portion of the back side of the pressure-receiving member 40, and right and left end portions of the lower connecting wire W2 are engaged with link members 23, which are fixed to the inner surfaces of the side frame main body portions 21 and configured to be swingable in the rearward direction, so that the lower portion of the pressure-receiving member 40 is connected to the right and left side frames 20.

According to the pressure-receiving member 40 as described above, when a backward movement load acts on the pressure-receiving member 40, the bent portions of the right and left ends of the upper connecting wire W2 deform and the right and left end portions of the lower connecting wire W1 move rearward by the swinging motion of the link members 23, so that the pressure-receiving member 40 moves rearward relative to the right and left side frames 20. Each link member 23 includes a conventional mechanism using a tension coil spring (shown without a reference numeral) and is thereby configured to swing rearward by the action of the backward movement load equal to or greater than a predetermined value.

The pressure-receiving member 40 mainly includes a pressure-receiving portion 41 disposed at the rear of the occupant seated on the seat cushion S1, and support portions 42 disposed at right and left sides of the pressure-receiving portion 41 and integrally formed with the pressure-receiving portion 41.

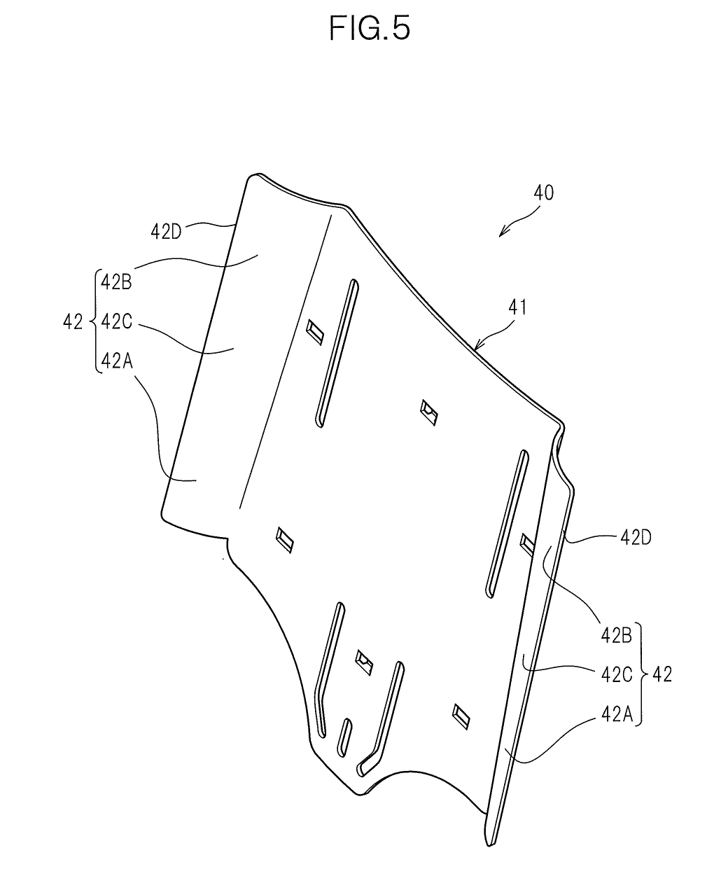

As seen in FIG. 4, the support portions 42 are disposed inside the seat back S2 and configured to support side portions of the upper body of the occupant via side portions 52 of the seat back pad 50, more specifically, side rear portions of the upper body; the support portions 42 extend obliquely in laterally outward and frontward directions from the right and left end portions of the pressure-receiving member 41. As seen in FIG. 5, each of the right and left support portions 42 consists of a lumbar region support portion 42A provided at a position corresponding to the height of the lumbar region of the occupant, a chest region support portion 42B provided above the lumbar region support portion 42A at a position corresponding to the height of the chest region of the occupant, and a joint portion 42C configured to join the lumbar region support portion 42A and the chest region support portion 42B together. The lumbar region support portion 42A mainly supports a side rear portion of the lumbar region of the occupant via the side portion 52 of the seat back pad 50, and the chest region support portion 42B mainly supports a side rear portion of the portion corresponding to the height of the chest in the upper body of the occupant.

As seen in FIG. 4, the front surfaces of the right and left support portions 42 are disposed in contact with the side portions 52 of the seat back pad 50 within the seat back S2. When the occupant sits on the seat cushion S1 and leans back against the seat back S2, the side portions 52 of the seat back pad 50 are caused to deform and the support portions 42 support from inside the seat back S2 the side portions of the upper body of the occupant via the side portions 52 of the seat back pad 50. Further, the support portions 42 are elastically deformable in the front-rear directions relative to the pressure-receiving portion 41, and when a load is applied from the front side, the support portions 42 can deform rearward while supporting the side portions of the upper body of the occupant.

The lower connecting wire W1 and the upper connecting wire W2 (not shown in FIG. 4) which connect the pressure-receiving member 40 with the right and left side frames 20 are disposed to pass through rear sides of the support portions 42. To be more specific, the lower connecting wire W1 is bent obliquely frontward and laterally outward from right and left ends of a portion thereof extending along the rear surface of the pressure-receiving portion 41, and disposed at the rear of the lumbar region support portions 42A with the bent portions extending along the rear surfaces of the lumbar region support portions 42A. Although not shown in the drawings, similar to the lower connecting wire W1 (see FIG. 4), the upper connecting wire W2 is also bent obliquely frontward and laterally outward from the right and left ends of the portion thereof extending along the rear surface of the pressure-receiving portion 41, and disposed at the rear of the chest region support portions 42B with the bent portions extending along the rear surfaces of the chest region support portions 42B. It is noted that right and left ends of the lower connecting wire W1 are bent toward the link members 23 of the side frames 20, and then engaged with the link members 23, and that right and left ends of the upper connecting wire W2 are bent toward the supporting tabs 14 of the side frames 20, and then engaged with the supporting tabs 14. Further, as seen in FIG. 3, the lower connecting wire W1 has portions, each of which includes a downwardly-protruding bent portion W11, disposed at the rear of the lumbar region support portions 42A, and the upper connecting wire W2 has portions, each of which includes an upwardly-protruding bent portion W21, disposed at the rear of the chest region support portions 42B.

As seen in FIG. 4, the seat back pad 50 covering the seat back frame F2 includes a center portion 51 facing the pressure-receiving member 41, and right and left side portions 52 provided at right and left sides of the center portion 51 and each configured to protrude frontward farther than the center portion 51. In this embodiment, since the support portions 42 which extend obliquely frontward are provided at right and left sides of the pressure-receiving member 40, for example, as compared to the configuration in which the support portions 42 extend laterally outward, space between the support portions 42 and the occupant is narrower. Therefore, as compared to the conventional seat construction (see chain double-dashed lines) without support portions 42, the right and left side portions 52 are thinner in the front-rear direction at their portions closer to the center portion 51.

Next, operation and advantageous effects of the car seat S configured as described above will be described.

The pressure-receiving member 40 of the car seat S includes the support portions 42; therefore, when the occupant is seated in the normal seating condition, the upper body (back) of the occupant can be supported by the pressure-receiving member 41 from the rear side via the seat back pad 50, and the side portions of the upper body of the occupant can be supported by the support portions 42 from the obliquely rearward directions. This configuration can stably support the upper body of the occupant as compared to the conventional seat structure without support portions 42.

In this embodiment, as described above, since the support portions 42 extend frontward relative to the pressure-receiving portion 41, the thickness of the seat back pad 50 (side portions 52) can be reduced at a position between the support portions 42 and the occupant; therefore, as compared to the configuration in which the side portions 52 are thick, the side portions of the upper body of the occupant can be more stably supported by the support portions 42. Further, since each of the support portions 42 includes the lumbar region support portion 42A and the chest region support portion 42B, each support portion 42 has an increased area to thereby more stably support the side portions of the upper body of the occupant as compared to the configuration in which each of the support portions 42 includes only one of the lumbar region support portion 42A and the chest region support portion 42B. Especially, in this embodiment, the lumbar region support portion 42A and the chest region support portion 42B are joined together by the joint portion 42C, and therefore the area of each support portion 42 is further increased and the side portions of the upper body of the occupant can be much more stably supported. Further, since each of the support portions 42 includes the lumbar region support portion 42A, the lumbar region of the occupant, that is, the lower portion of the upper body of the occupant can be stably supported, to thereby stabilize the seating posture of the occupant.

Further, in this embodiment, since the support portions 42 are integrally formed with the pressure-receiving portion 41 and extend frontward relative to the pressure-receiving portion 41, the pressure-receiving member 40 has a generally U-shaped configuration as viewed from the top side. This can improve the rigidity of the pressure-receiving member 40 provided with the support portions 42, so that the upper body of the occupant can be more stably supported. Further, since the support portions 42 are integrally formed with the pressure-receiving portion 41, the structure of the car seat S can be simplified while preventing the number of parts from being increased, as compared to the configuration in which the support portions 42 and the pressure-receiving portion 41 are formed as discrete parts.

Further, in this embodiment, since the lower connecting wire W1 is disposed to pass through the rear sides of the lumbar region support portions 42A, a load applied to the lumbar region support portions 42A can also be supported by the lower connecting wire W1. Especially, in this embodiment, the lower connecting wire W1 includes the bent portions W11 at the rear sides of the lumbar region support portions 42A, so that those portions of the lower connecting wire W1 which are disposed rearward of the lumbar region support portions 42A have increased areas; therefore, a load applied to the lumbar region support portions 42A can be stably supported by the lower connecting wire W1. With these configurations, the lumbar region of the occupant can be more stably supported. Similarly, the upper connecting wire W2 is disposed to pass through the rear sides of the chest region support portions 42B, and further the upper connecting wire W2 includes the bent portions W21 at the rear sides of the chest region support portions 42B; these configurations make it possible to more stably support the chest region of the occupant.

As seen in FIG. 5, each of the support portions 42 has a roughly inverted-triangular shape such that the laterally outer end portion 42D thereof slants toward the laterally ends of the pressure-receiving portion 41 with distance decreasing from the upper side toward the lower side of the support portion 42 (i.e., tapering to narrow from the upper toward the lower side of the support portion 42); therefore, the support portions 42 can be arranged in the seat back S2 along the physique of the occupant. This makes it possible to more stably support the side portions of the upper body of the occupant.

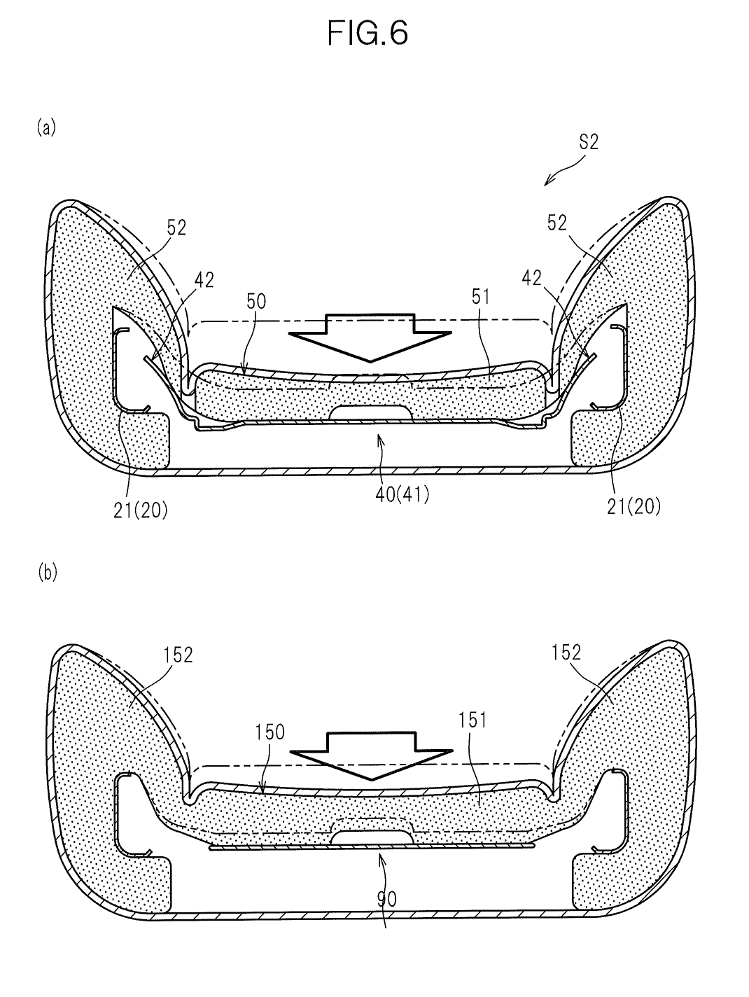

With reference to FIG. 6, description will be given of the operation and advantageous effects of the car seat S when the car is rear-ended by another car or when the car collides at the rear portion thereof with another car or the like while reversing (hereinafter collectively referred to as a rear-end collision). It is noted that FIG. 6(a) is a view showing a car seat S according to this embodiment, and FIG. 6(b) is a view showing a car seat according to a comparative (conventional) example in which the pressure-receiving member 90 does not includes support portions. To give a supplementary explanation, the car seat S according to this embodiment is configured such that the right and left side portions 52 of the seat back pad 50 have a reduced thickness in the front-rear direction at portions thereof closer to the center portion 51, as compared to those portions of the right and left side portions 152 of the seat back pad 150 according to the comparative embodiment which are closer to the center portion 151.

When a backward movement load is applied from the occupant to the seat back S2 in a rear-end collision, as seen in FIG. 6(a), the seat back pad 50 deforms and moves rearward from a position indicated by chain double-dashed lines where a load has not been applied, and the pressure-receiving member 40 pushed by the seat back pad 50 also moves rearward. It is noted that the right and left side portions 52 of the seat back pad 50 according to this embodiment as shown in FIG. 6(a) are thinner in the front-rear direction than the right and left side portions 152 of the seat back pad 150 according to the comparative embodiment as shown in FIG. 6(b) and thus easily deformable; therefore, when the backward movement load is applied, the right and left side portions 52 according to this embodiment can deform more quickly and more largely than the right and left side portions 152 according to the comparative embodiment. This makes it possible to allow the entire upper body of the occupant to quickly and deeply sink into the seat back pad 50. As a result, the head of the occupant quickly approaches the headrest S3, so that an impact applied to the neck of the occupant due to the rear-end collision can be further reduced.

Although embodiments of the present invention have been described, the present invention is not limited to the above-described embodiments. It is to be understood that modifications and changes may be made to any of the specific configurations where necessary without departing from the gist of the present invention.

Specific configuration of the support portions 42 as shown in the above embodiment has been described by way of example only, and the present invention is not limited to this configuration shown in the above embodiment. For example, in the above embodiment, the lumbar region support portion 42A and the chest region support portion 42B are joined together by the joint portion 42C. However, the present invention is not limited to this configuration, and the lumbar region support portion 42A and the chest region support portion 42B may be discretely provided (without being connected together). Further, both of the lumbar region support portion 42A and the chest region support portion 42B are provided in the above embodiment. However, the present invention is not limited to this configuration; for example, the support portions may be provided only at positions corresponding to the height of the lumbar region of the occupant, or alternatively, only at positions corresponding to the height of the chest region of the occupant.

In the above embodiment, as seen in FIG. 3, the lower connecting wire W1 (first connecting wire) includes the bent portions W11 disposed at the rear of the lumbar region support portions 42A (support portions 42) and bent to protrude downward. However, the present invention is not limited to this configuration; for example, the first connecting wire may include bent portions disposed at the rear of the support portions and bent to protrude upward. Further, the first connecting wire may include both upwardly-protruding bent portions and downwardly-protruding bent portions at the rear of the support portions. Further, the first connecting wire may not include bent portions at the rear of the support portions. For the above modifications, the same can be applied to the second connecting wire.

In the above embodiment, as seen in FIG. 4, the right and left end portions of the lower connecting wire W1 (first connecting wire) are disposed to extend along the rear surfaces of the lumbar region support portions 42A (support portions 42). However, the present invention is not limited to this configuration; for example, the first connecting wire may be disposed at a position remote from the support portions. The same can be applied to the second connecting wire. It is noted that a wire-like member (lower connecting wire W1 and upper connecting wire W2) is exemplified in the above embodiment as a member for connecting the pressure-receiving member 40 (pressure-receiving portion 41) to the right and left side frames 20. However, the present invention is not limited to this configuration; for example, such a member for connecting the pressure-receiving portion to the right and left side frames may be coil spring-like members or a belt-shaped (strip-shaped) member.

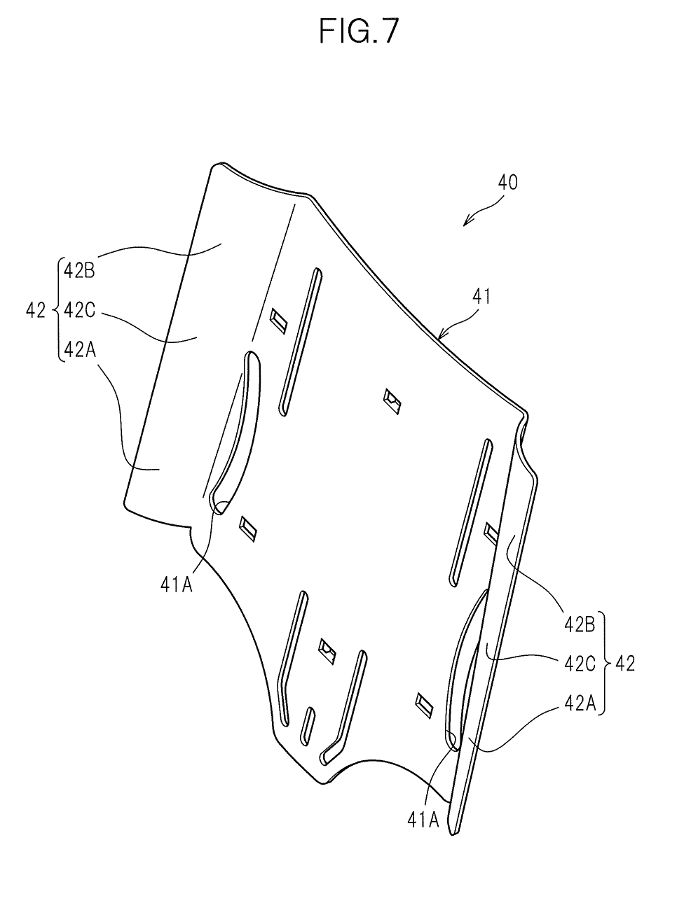

Specific configuration of the pressure-receiving portion 41 as shown in the above embodiment has been described by way of example only, and the present invention is not limited to this configuration shown in the above embodiment. For example, as seen in FIG. 7, the pressure-receiving portion 41 may include through-holes 41A (slits). This configuration makes it possible to reduce the weight of the pressure-receiving portion 41 (pressure-receiving member 40). Further, the pressure-receiving portion 41 and the support portions 42 are formed as plate-like members in the above embodiment. However, the present invention is not limited to this configuration; the pressure-receiving portion 41 and the support portions 42 may not be plate-like members.

Specific configuration of the seat frame F (seat cushion frame F1 and seat back frame F2) as shown in the above embodiment has been described by way of example only, and the present invention is not limited to this configuration shown in the above embodiment. For example, each of the right and left side frames 20 of the seat back frame F2 consists of the pipe-shaped vertical pipe portion 13 and the plate-like side frame main body portion 21 in the above embodiment. However, the present invention is not limited to this configuration; for example, each of the side frames may consist of the pipe-shaped frame only or the plate-like frame only.

In the above embodiment, the car seat S used in an automobile is illustrated as an example of a vehicle seat. However, the present invention is not limited to the car seat and applicable to other vehicle seat, such as a seat for marine vessel and a seat for aircraft.

### Second Embodiment

With reference to FIGS. 1 and 8-15, a second embodiment of the present invention and modified embodiments thereof will be described. Parts similar to those previously described in the above first embodiment are denoted by the same reference numerals and detailed description thereof will be omitted.

In this embodiment, the pressure-receiving member 40 consists of a pressure-receiving portion 141 and support portions 70, which are formed as discrete parts.

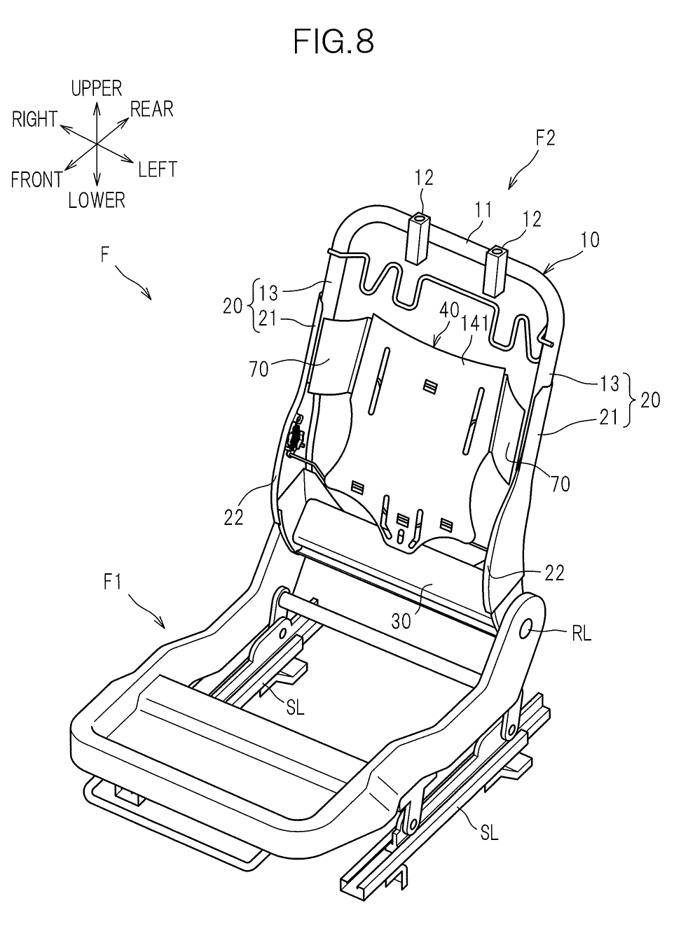

As seen in FIG. 8, the pressure-receiving portion 141 disposed at the rear of the occupant seated on the seat cushion S1 and configured to support the upper body of the occupant in a manner that allows a backward movement thereof is located between the right and left side frames 20.

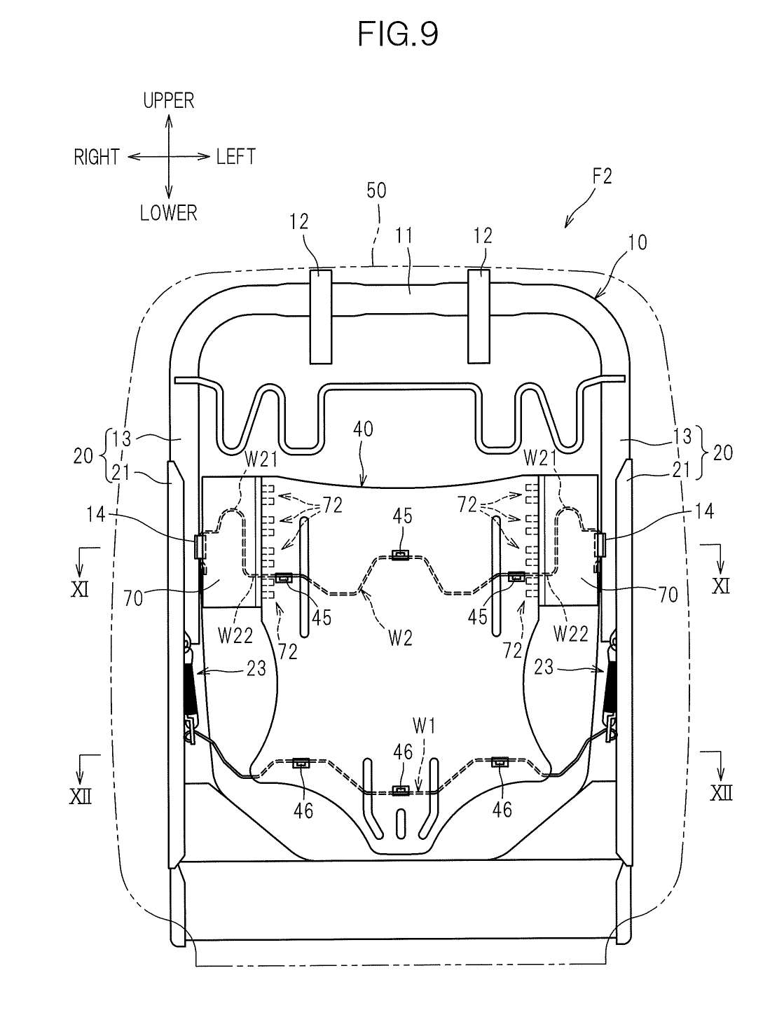

The pressure-receiving member 141 is a plate-like member made of plastic resin, and as seen in FIG. 9, the pressure-receiving member 141 is provided to be movable in the rearward direction relative to the right and left side frames 20, via the upper connecting wire W2 and the lower connecting wire W1 extending substantially in the right-left direction. To be more specific, the upper connecting wire W2 is engaged with engagement portions 45 formed at an upper portion of the back side of the pressure-receiving portion 141, and each of right and left end portions of the upper connecting wire W2 is engaged with a supporting tab 14 fixed to the vertical pipe portion 13, so that the upper portion of the pressure-receiving portion 141 is connected to the right and left side frames 20. The lower connecting wire W1 is engaged with engagement portions 46 formed at a lower portion of the back side of the pressure-receiving portion 141, and the right and left end portions of the lower connecting wire W2 are engaged with link members 23, which are fixed to the inner surfaces of the side frame main body portions 21 and configured to be swingable in the rearward direction, so that the lower portion of the pressure-receiving portion 141 is connected to the right and left side frames 20.

According to the pressure-receiving portion 141 as described above, when a backward movement load acts on the pressure-receiving portion 141, the bent portions of the right and left ends of the upper connecting wire W2 deform and the right and left end portions of the lower connecting wire W1 move rearward by the swinging motion of the link members 23, so that the pressure-receiving portion 141 moves rearward relative to the right and left side frames 20. Each link member 23 includes a conventional mechanism using a tension coil spring (shown without a reference numeral) and is thereby configured to swing rearward by the action of the backward movement load equal to or greater than a predetermined value.

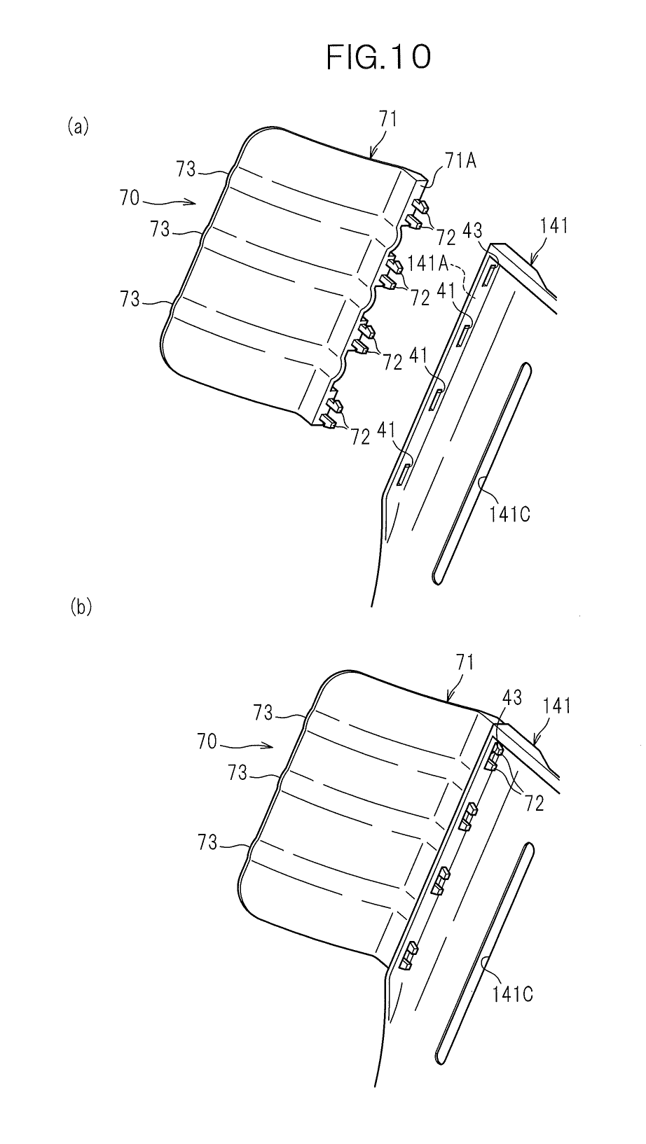

Provided at an upper portion of the pressure-receiving portion 141, more specifically, at right and left sides of a portion of the pressure-receiving portion 141 corresponding to the height of the chest region of the occupant are support portions 70 made of plastic resin. The support portions 70 are members for supporting the side portions of the upper body of the occupant in the seat back S2, and as seen in FIGS. 10(a) and 10(b), the support portions 70 are separately formed (as discrete parts) with the pressure-receiving portion 141 and configured to be detachably attached to the pressure-receiving portion 141. The right and left support portions 70 (only one of them is shown in FIGS. 10(a) and 10(b)) are bilaterally symmetrical, each of which mainly includes a plate-like support portion main body 71, engagement claws 72 extending from the support portion main body 71, and beads (ribs) 73 provided on the support portion main body 71.

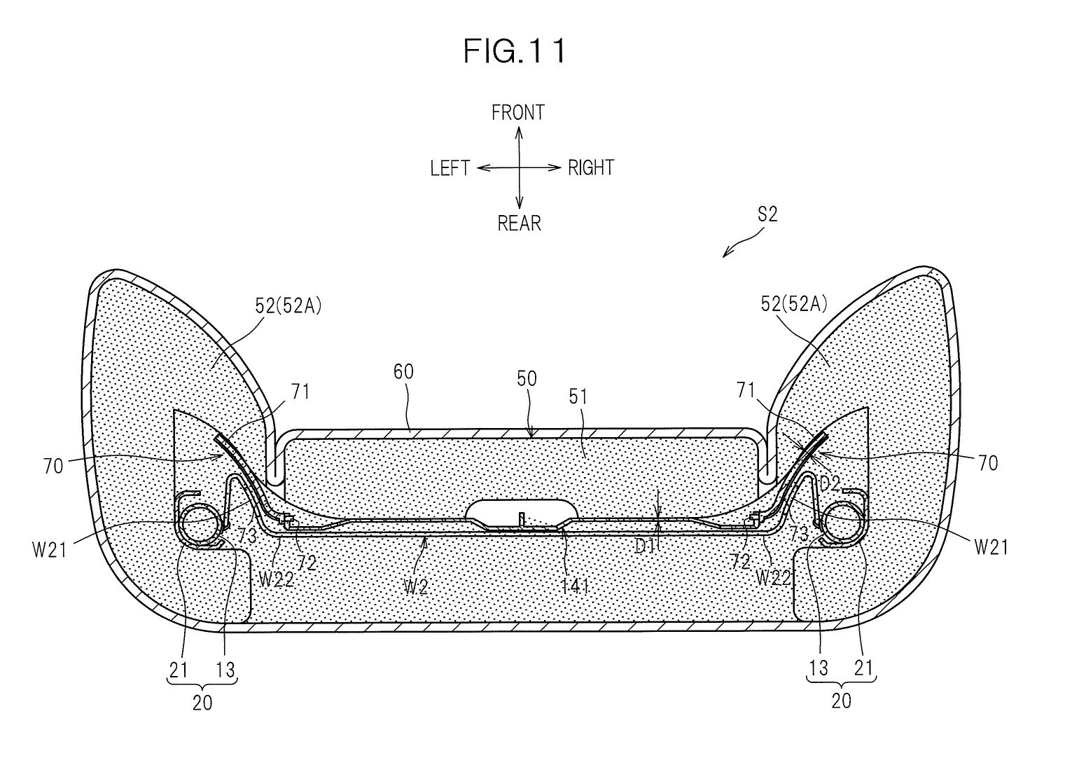

As seen in FIG. 11, in a state where the support portions 70 are attached to the pressure-receiving portion 141, the support portion main bodies 71 extend obliquely in laterally outward and frontward directions from the right and left end portions of the pressure-receiving portion 141 and support the side portions of the upper body of the occupant, more specifically, those portions of the side portions which are closer to the back side of the upper body, via an upper side portion 52A of the seat back pad 50 (see also FIG. 1). Each of the support portion main bodies 71 has a thickness D2 which is thicker than a thickness D1 of the pressure-receiving portion 141. The support portion main bodies 71 are elastically deformable in the front-rear directions relative to the pressure-receiving portion 141; when a load is applied from the front side, the support portion main bodies 71 can deform backward while supporting the side portions of the upper body of the occupant.

As seen in FIG. 10(a), four engagement claws 72 are arranged one after another in the upper-lower direction at the laterally inner end face 71A of each support portion main body 71. Each of the engagement claws 72 consists of a pair of upper and lower extension strips extending from the end face 71A toward the pressure-receiving portion 141, and a distal end portion of each extension strip has a hook portion protruding away from the other extension strip and tapering toward the distal end portion.

Provided at right and left end faces 141A of an upper portion of the pressure-receiving portion 141 are four generally rectangular-shaped engagement holes 43 arranged one after another in the upper-lower direction at distances corresponding to those at which the four pairs of engagement claws 72 are arranged; each engagement claw 72 is engageable with the corresponding engagement hole 43. As seen in FIG. 10(b), the support portion 70 is attached to the pressure-receiving portion 141 by the engagement of the engagement claws 72 with the corresponding engagement holes 43. As described above, the pressure-receiving portion 141 and the support portions 141 include four connecting portions which are arranged one after another in the upper-lower direction, that is, the engagement claws 72 and the engagement holes 43. As seen in FIG. 9, these engagement claws 72 and engagement holes 43 (joint portions of the pressure-receiving portion 141 and the support portions 70) are located laterally inside the side frames 20.

Referring back to FIG. 10, the beads 73 protrude substantially rearward in the support portion main body 71 and each takes an elongated shape extending substantially along the lateral direction (in a direction in which the engagement claws 72 extend). In this embodiment, the support portion main body 71 of each of the support portions 70 includes three beads 73 which are arranged one after another in the upper-lower direction. With this configuration, each support portion main body 71 has a rugged cross-section, so that the rigidity of the support portion main body 71 can be enhanced.

The pressure-receiving portion 141 and the support portions 70 can be manufactured by molding, such as injection molding process of injecting heated plastic resin into a mold.

As seen in FIGS. 9 and 11, the upper connecting wire W2 configured to connect the pressure-receiving portion 141 with the right and left side frames 20 is so disposed as to avoid the engagement claws 72 and the engagement holes 43, passing through the rear sides of the pressure-receiving portion 141 and the support portions 70. To be more specific, the upper connecting wire W2 has horizontal portions W22 extending laterally, and each of the horizontal portions W22 is disposed to pass through a space between two connecting portions (engagement claws 72) which are arranged one above the other in the upper-lower direction. Further, the right and left end portions of the upper connecting wire W2 are bent frontward from the laterally outer ends of the horizontal portions W22 (only one of them is shown) at the rear sides of the support portions 70, and then bent such that each of the right and left end portions thereof extends along the rear surface of the support portion main body 71 and forms an upwardly-protruding bent portion W21. Further, the upper connecting wire W2 is bent at the ends of the bent portions W21 toward the supporting tabs 14 of the side frames 20, and then engaged with the supporting tabs 14.

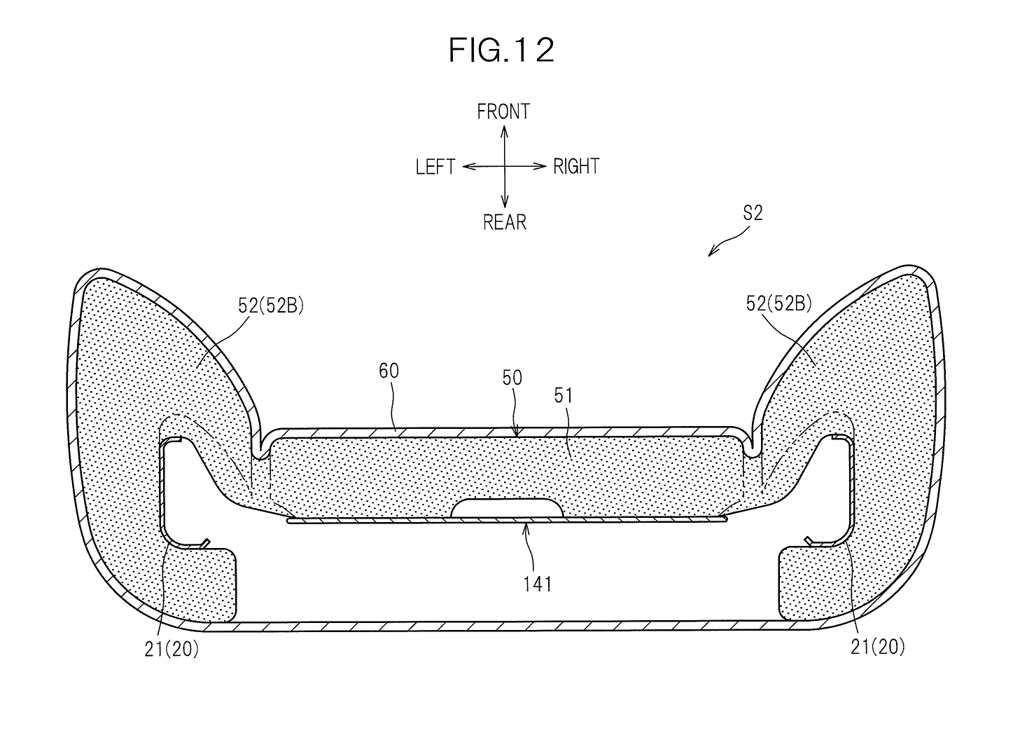

As seen in FIGS. 1 and 11, the seat back pad 50 covering the seat back frame F2 includes a center portion 51 configured to face the back region of the upper body of the occupant, and right and left side portions 52 provided at right and left sides of the center portion 51 and each configured to protrude frontward farther than the center portion 51. Each of the right and left side portions 52 is provided with the support portion 70 at the upper side portion 52A provided at the height of the seat back S2 corresponding to the chest region of the occupant, with the result that those portions of the side portions 52 which are closer to the center portion 51 are formed to be thinner in the front-rear direction than those of the lower side portions 52B provided at the height position corresponding to the lumbar region of the occupant where the support portions 70 shown in FIG. 12 are not provided. In order to clearly explain that the upper side portions 52A are thinner in the front-rear direction than the lower side portions 52B, the contours of the rear sides of the upper side portions 52A are shown in FIG. 12 by chain double-dashed lines.

Next, operation and advantageous effects of the car seat S configured as described above will be described.

As seen in FIG. 11, the car seat S includes the support portions 70 attached to the pressure-receiving portion 141; therefore, when the occupant is seated in the normal seating condition, the upper body (back) of the occupant can be supported by the pressure-receiving portion 141 from the rear side via the seat back pad 50, and the side portions of the upper body of the occupant can be supported by the support portions 70 from the obliquely rearward directions. This configuration can stably support the upper body of the occupant as compared to the structure without support portions 70.

In this embodiment, since the beads 73 are provided on each of the support portions 70 (support portion main bodies 71), the rigidity of the support portion 70 is enhanced. Further, since the support portion 70 is configured such that the thickness D2 of the support portion main body 71 is greater than the thickness D1 of the pressure-receiving portion 141, the rigidity of the support portion 70 is enhanced as well. With these configurations, the side portions of the upper body of the occupant can be more stably supported by the support portions 70.

Further, in this embodiment, since the upper connecting wire W2 is disposed to pass through the rear sides of the support portions 70, a load applied to the support portions 70 can also be supported by the upper connecting wire W2. Especially, in this embodiment, the upper connecting wire W2 includes the upwardly-protruding bent portions W21 at the rear sides of the support portions 70 as shown in FIG. 9, so that those portions of the upper connecting wire W2 which are disposed rearward of the support portions 70 have increased areas; therefore, a load applied to the support portions 70 can be stably supported by the upper connecting wire W2. With these configurations, the side portions of the upper body of the occupant can be more stably supported.

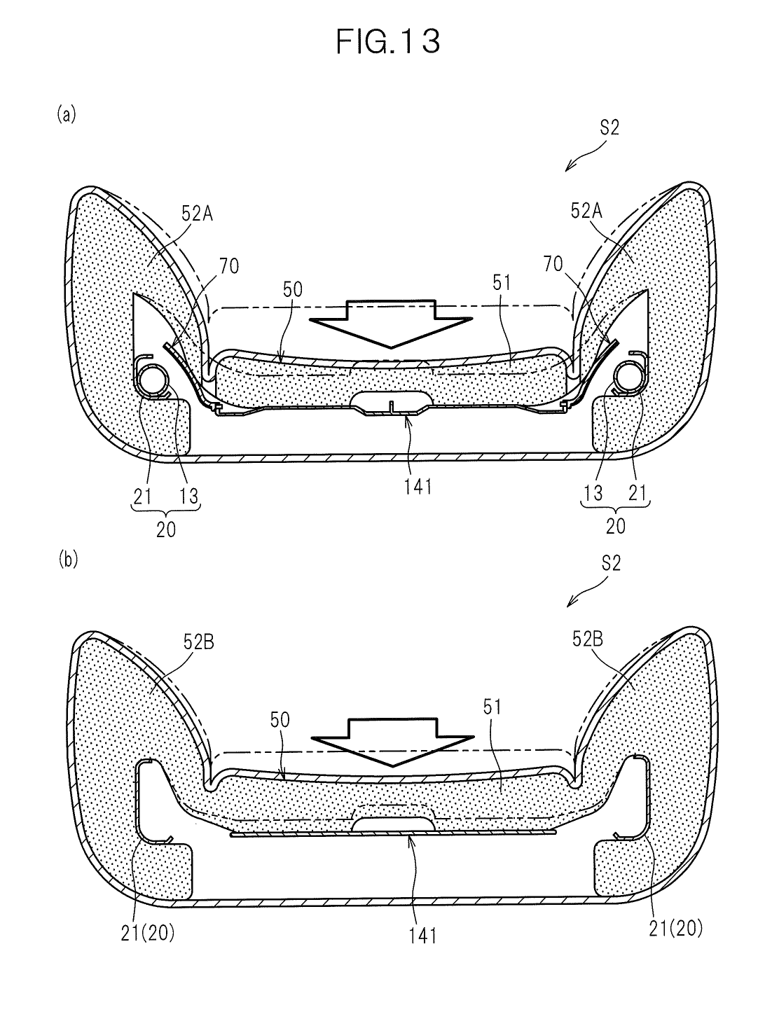

When the car is rear-ended by another car or when the car collides at the rear portion thereof with another car or the like while reversing (i.e., rear-end collision) and a backward movement load is applied from the occupant to the seat back S2, as seen in FIGS. 13(a) and 13(b), the seat back pad 50 deforms and moves rearward from a position indicated by chain double-dashed lines where a load has not been applied, and the pressure-receiving portion 141 pushed by the seat back pad 50 also moves rearward. It is noted that the upper side portions 52A of the seat back pad 50 as shown in FIG. 13(a) are thinner in the front-rear direction than the lower side portions 52B of the seat back pad 150 and thus easily deformable; therefore, when the backward movement load is applied, the upper side portions 52A can deform more quickly and more largely than the lower side portions 52B shown in FIG. 13(b). This makes it possible to allow the upper portion of the upper body of the occupant (portion corresponding to the height position of the chest region) to more quickly and more deeply sink into the seat back pad 50 than the lower portion of the upper body of the occupant (portion corresponding to the height position of the lumbar region) does. As a result, the head of the occupant closer to the upper portion of the upper body quickly approaches and thus gets supported by the headrest S3, so that an impact applied to the neck of the occupant due to the rear-end collision can be further reduced.

According to the car seat S configured as described above, as seen in FIG. 10(a), the pressure-receiving portion 141 and the support portions 70 are formed as discrete parts, so that the pressure-receiving portion 141 and the support portions 70 can be manufactured separately; therefore, as compared to the case where the pressure-receiving portion integral with the support portions (hereinafter referred to as an integrated pressure-receiving member) is manufactured, design variations of the pressure-receiving portion 141 and the support portions 70 such as manufacturable size and shape can be increased. To be more specific, if parts such as the pressure-receiving portion 141, the support portions 70, and the integrated pressure-receiving member are manufactured, for example, by injection molding, a mold for manufacturing the integrated pressure-receiving member has a cavity shape which is larger and more complicated than a mold for manufacturing the pressure-receiving portion 141; therefore, there are various restrictions for size, shape and the like of the pressure-receiving portion and the support portions, when considering liquidity of the plastic resin, curing of the plastic resin, and removal of the molded part from the mold. However, manufacturing the pressure-receiving portion 141 and the support portions 70 separately makes it possible to lessen these restrictions; therefore, design variations such as manufacturable size and shape can be increased. Accordingly, since the pressure-receiving portion 141 and the support portions 70 of the car seat S are formed as discrete parts, the degree of flexibility in designing the pressure-receiving portion 141 and the support portions 70 can be improved.

In this embodiment, since the support portions 70 are configured to be detachably attached to the pressure-receiving portion 141, namely, attachable to and detachable from the pressure-receiving portion 141, the support portions 70 are replaceable. Therefore, for example, replacement of the support portions 70 and reuse of the pressure-receiving portion 141 can be accomplished after the distribution of the car seat S.

Further, in this embodiment, since each of the support portions 70 (support portion main bodies 71) is provided with engagement claws 72 engageable with the engagement holes 43 of the pressure-receiving portion 141, each of the support portions 70 can be readily attached to the pressure-receiving portion 141 by means of engagement between the engagement claws 72 and the engagement holes 43. In this embodiment, the support portion main body 71 (vicinity of the end face 71A) and the right and left end portions (vicinity of the end faces 141A) of the upper portion of the pressure-receiving portion 141 are formed to be thicker in the front-rear direction in order to provide the engagement claws 72 and the engagement holes 43. With this configuration, when a load is applied from the occupant to the support portions 70 attached to the pressure-receiving portion 141, the end faces 71A, 141A contact with each other, so that the rearward movements of the support portions 70 can be restricted; this makes it possible to prevent the engagement claws 72 (support portion 70) from coming off the engagement holes 43 (pressure-receiving portion 141). Further, the amount of rearward deformation of the support portions 70 may be restricted because the end faces 71A, 141A contact with each other to restrict the rearward movements of the support portions 70; however, as seen in FIG. 10(b), an elongated through-hole 141C (slit) extending in the upper-lower direction may be formed in the vicinity of the right and left end faces 141A of the pressure-receiving portion 141 to make the pressure-receiving portion 141 easily deformable in the vicinity of the through-hole 141C, so that the amount of deformation of the support portions 70 (both right and left sides of the pressure-receiving portion 141) can be ensured.

Further, in this embodiment, since the upper connecting wire W2 is so disposed as to avoid the engagement claws 72 and the engagement holes 43, more specifically, the horizontal portion W22 of the upper connecting wire W2 is disposed to pass through the space between the two engagement claws 72 which are arranged one above the other in the upper-lower direction as shown in FIG. 9, the interference between the upper connecting wire W2 and the engagement claws 72 can be suppressed. Further, in this embodiment, since the engagement claws 72 are located between (arranged inside) the side frames 20 in the lateral direction, the interference between the engagement claws 72 and the side frames 20 can also be suppressed. With these configurations, an undesirable load is less likely to be applied to the vicinity of the engagement claws 72; this makes it possible to prevent, for example, the support portions 70 from coming off the pressure-receiving portion 141.

Although embodiments of the present invention have been described, the present invention is not limited to the above-described embodiments. It is to be understood that modifications and changes may be made to any of the specific configurations where necessary without departing from the gist of the present invention.

Specific configuration of the support portions 7 as shown in the above embodiment has been described by way of example only, and the present invention is not limited to this configuration shown in the above embodiment.

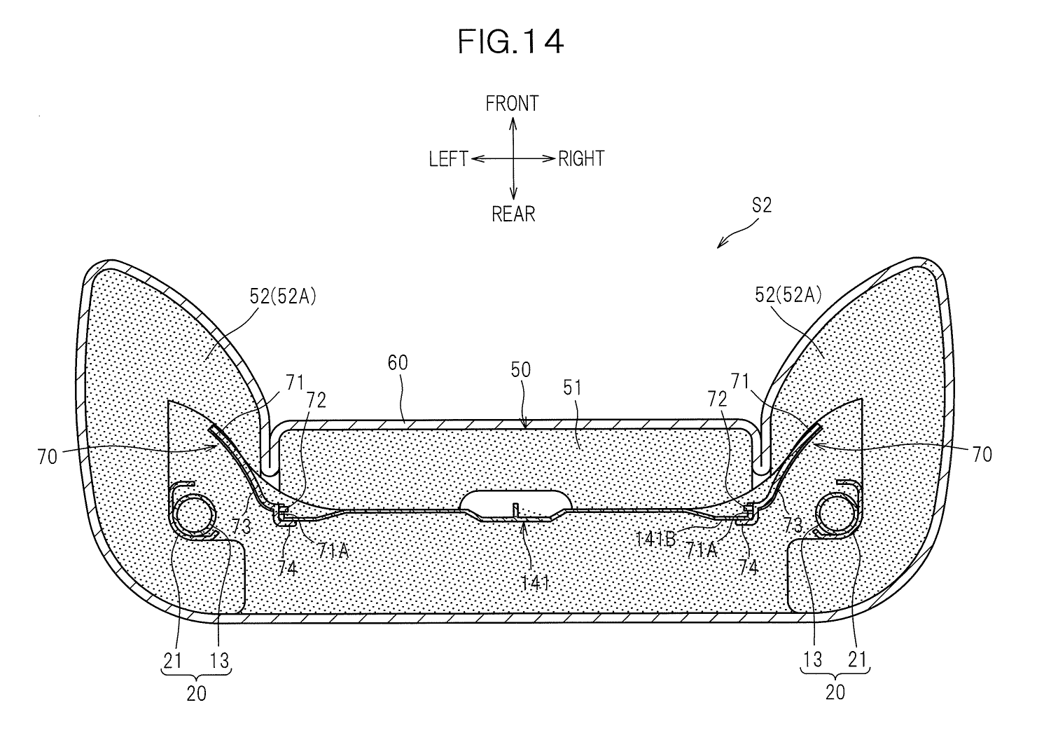

For example, as seen in FIG. 14, each of the support portions 70 may further include a restriction portion 74 configured to restrict a rearward movement thereof, in addition to the support portion main body 71, the engagement claws 72 and the beads 73. To be more specific, each of the restriction portions 74 exemplified in FIG. 14 extends from the rear portion of the end face 71A of the support portion main body 71 toward the pressure-receiving portion 141, and it takes a substantially plate-like shape extending along the rear surface 141B of the pressure-receiving portion 141 to the rear side of one of the right and left ends of the pressure-receiving portion 141. Providing these restriction portions 74 makes it possible to restrict the rearward movements of the support portions 70; therefore, the side portions of the upper body of the occupant can be more stably supported by the support portions 70. Further, restricting the rearward movement of the support portions 70 makes it possible to prevent the engagement claws 72 (support portions 70) from coming off the engagement holes 43 (pressure-receiving portion 141).

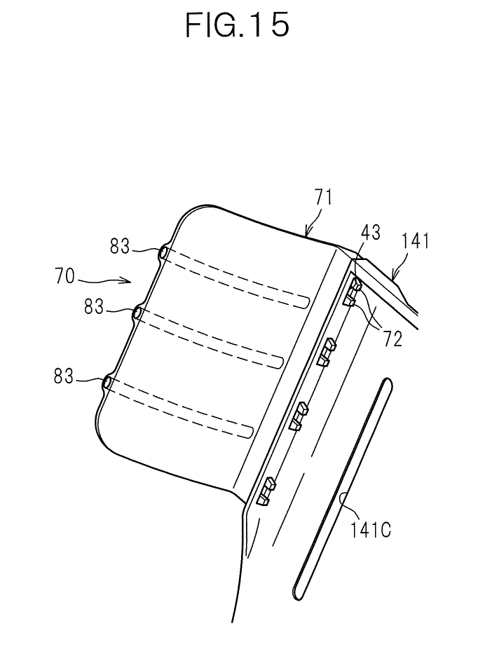

In the above embodiment, each of the support portions 70 includes the beads 73 formed on the support portion main body 71. However, the present invention is not limited to this configuration. For example, as seen in FIG. 15, a plurality of metallic wires 83 may be embedded in the support portion main body 71. This support portion main body 71 may be formed by insert molding wherein a plurality of wires 83 are inserted into a mold and thereafter plastic resin is filled into the mold.

Like the configuration with the beads 73, this configuration can also enhance the rigidity of the support portion main body 71.

In the above embodiment, each of the pressure-receiving portion 141 and the support portions 70 includes four engagement claws 72 or four engagement holes 43 arranged one after another in the upper-lower direction at the right and left sides of the pressure-receiving portion 141. However, the present invention is not limited to this configuration. For example, the number of engagement claws 72 and engagement holes 43 may be less than four or more than four. Further, the engagement claws may be formed on the pressure-receiving portion, and the engagement holes may be formed in the support portions. Further, the plurality of engagement claws and engagement holes may be arranged in the lateral direction instead of being arranged in the upper-lower direction. In the above embodiment, the configuration in which the support portions 70 are detachably attached to the pressure-receiving portion 141 by the engagement between the engagement claws 72 and the engagement holes 43 has been exemplified. However, the present invention is not limited to this configuration. For example, the support portions may be detachably fastened to the pressure-receiving portion, for example, by bolts and nuts. Further, in the above embodiment, the support portions 70 are detachably attached to the pressure-receiving portion 141. However, the present invention is not limited to this configuration. For example, the support portions may be non-detachably fixed to the pressure-receiving portion, for example, by adhesive.

In the above embodiment, the upper connecting wire W2 (connecting wire) has the horizontal portions W22 each extending laterally, and each of the horizontal portions W22 is disposed to pass through the space between two engagement claws 72 (connecting portions) which are arranged one above the other in the upper-lower direction. However, the present invention is not limited to this configuration. For example, the connecting wire may have an upwardly-protruding bent portion or a downwardly-protruding bent portion, and a laterally-extending portion thereof (top portion of the bent portion) may be disposed to pass through a space between two connecting portions which are arranged one above the other. Further, in the above-embodiment, the upper connecting wire W2 is so disposed as to avoid the engagement claws 72 and the engagement holes 43 (i.e., joint portions). However, the present invention is not limited to this configuration. For example, in the configuration in which the support portions are fixed to the pressure-receiving portion, for example, by adhesive, the connecting wire may be disposed across the joint portion (bonded portion).

In the above embodiment, the thickness D2 of each of the support portion main bodies 71 (support portions 70) is greater than the thickness D1 of the pressure-receiving portion 141. However, the present invention is not limited to this configuration. For example, the thickness of the support portions may be the same as that of the pressure-receiving portion.

In the above embodiment, as seen in FIG. 9, the upper connecting wire W2 (connecting wire) includes the bent portions W21 disposed at the rear of the support portions 70 and bent to protrude upward. However, the present invention is not limited to this configuration; for example, the connecting wire may include bent portions disposed at the rear of the support portions and bent to protrude downward. Further, the connecting wire may include both upwardly-protruding bent portions and downwardly-protruding bent portions at the rear of the support portions. Further, the connecting wire may not include bent portions at the rear of the support portions.

In the above embodiment, a wire-like member (upper connecting wire W2 and lower connecting wire W1) is exemplified in the above embodiment as a member for connecting the pressure-receiving portion 41 to the right and left side frames 20. However, the present invention is not limited to this configuration; for example, such a member for connecting the pressure-receiving portion to the right and left side frames may be coil spring-like members or a belt-shaped (strip-shaped) member.

Specific configuration of the seat frame F (seat cushion frame F1 and seat back frame F2) as shown in the above embodiment has been described by way of example only, and the present invention is not limited to this configuration shown in the above embodiment. For example, each of the right and left side frames 20 of the seat back frame F2 consists of the pipe-shaped vertical pipe portion 13 and the plate-like side frame main body portion 21 in the above embodiment. However, the present invention is not limited to this configuration; for example, each of the side frames may consist of the pipe-shaped frame only or the plate-like frame only. Further, each of the pressure-receiving portion 141 and the support portions 70 takes a plate-like shape. However, the present invention is not limited to this configuration; the pressure-receiving portion and the support portions may not take a plate-like shape.

In the above embodiment, the car seat S used in an automobile is illustrated as an example of a vehicle seat. However, the present invention is not limited to the car seat and applicable to other vehicle seat, such as a seat for marine vessel and a seat for aircraft.

### Third Embodiment

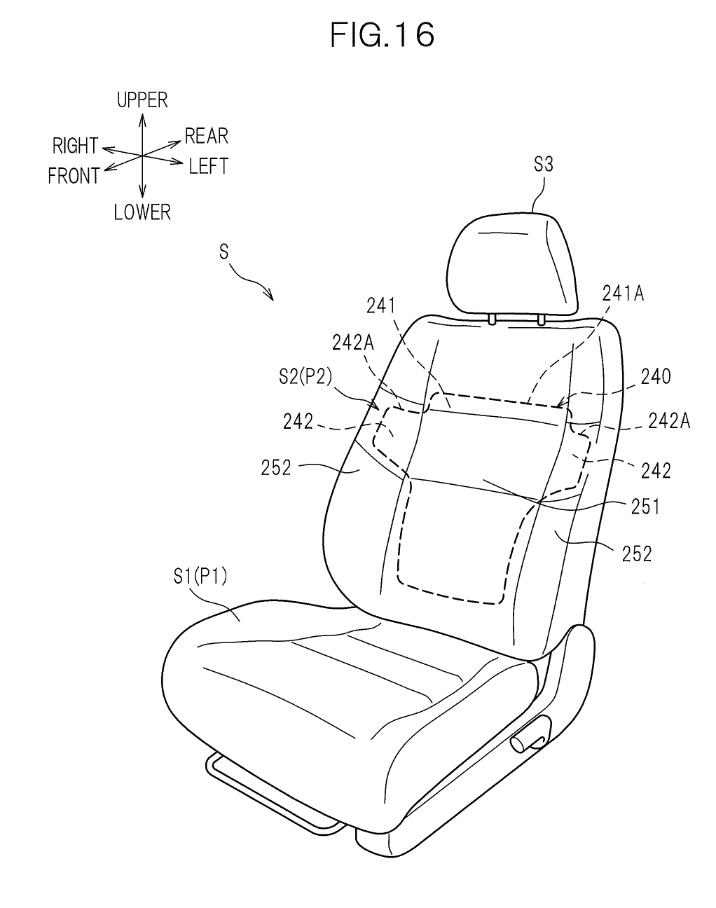

With reference to FIGS. 16-24, a third embodiment of the present invention and modified embodiments thereof will be described.

In the following description, the overall configuration of a car seat will be described briefly as an example of a vehicle seat, and then characteristic configurations according to the present invention will be described in detail.

As seen in FIG. 16, a car seat S is configured as a seat used for a driver's seat of a car, and mainly includes a seat cushion S1, a seat back S2, and a headrest S3.

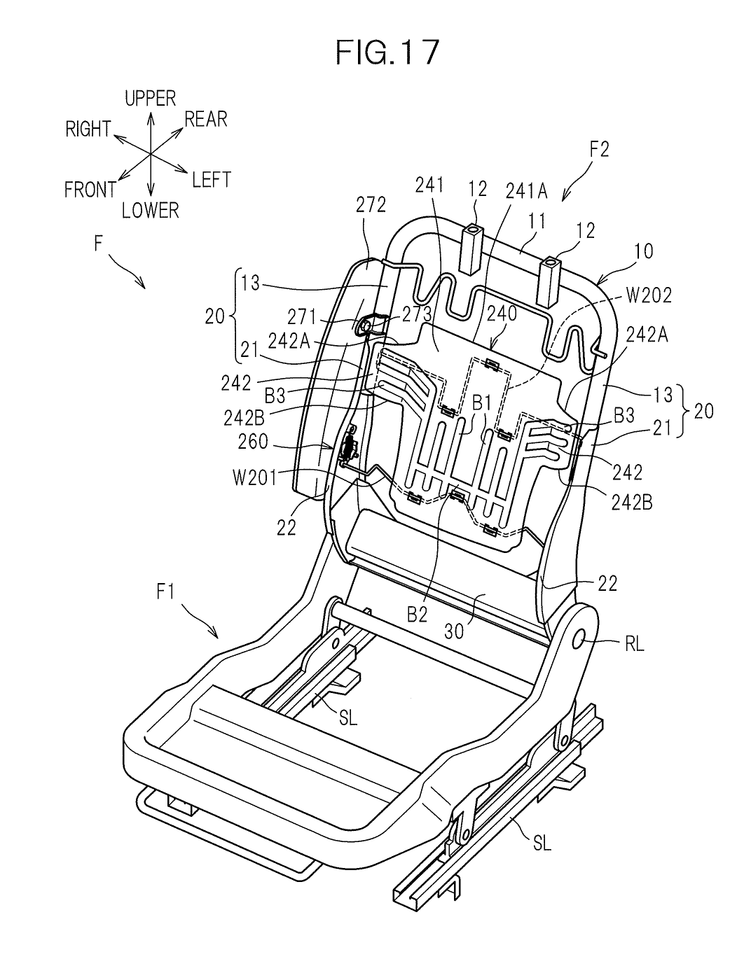

A seat frame F as shown in FIG. 17 is embedded in the seat cushion S1 and the seat back S2. The seat frame F mainly includes a seat cushion frame F1 constituting a frame of the seat cushion S1, and a seat back frame F2 constituting a frame of the seat back S2. The seat cushion S1 is configured such that the seat cushion frame F1 is covered with a seat cushion pad P1 made of a cushion material such as urethane foam, and a skin material made of synthetic leather or fabric. The seat back S2 is configured such that the seat back frame F2 is covered with a seat back pad P2 made of a cushion material, and a skin material made of synthetic leather or fabric.

The seat back pad P2 includes a center portion 251 configured to face the back region of the upper body of the occupant, and right and left side portions 252 provided at right and left sides of the center portion 251 and each configured to protrude frontward farther than the center portion 251.

As seen in FIG. 17, the seat cushion frame F1 is installed on a floor of the car via slide rails SL. This makes it possible to allow the position of the car seat S to be adjustable in the front-rear direction. Further, a lower portion of the seat back frame F2 is connected to a rear portion of the seat cushion frame F1 via a reclining mechanism RL in such a manner as to be tiltable in the front-rear directions. This makes it possible to allow the seat back S2 to be tiltable in the front-rear directions relative to the seat cushion S1.

The seat back frame F2 mainly consists of an upper frame 10, right and left side frames 20, and a lower frame 30; the upper frame 10, the right and left side frames 20, and the lower frame 30 are joined together, for example, by welding to thereby form a frame-like configuration. A pressure-receiving member 240 to be described later is disposed inside the seat back frame F2.

The upper frame 10 is formed by bending a pipe material into a substantially U-shape configuration and includes a lateral pipe portion 11 extending in the right-left direction, and a pair of right and left support brackets 12 for attachment of the headrest S3 are fixed by welding to the front side of the lateral pipe portion 11. Right and left vertical pipe portions 13 of the upper frame 10 extend in the upper-lower direction; right and left side frame main body portions 21 are joined to lower portions of the vertical pipe portions 13 and made into integral parts to thereby form right and left side frames 20.

Each of the right and left side frame main body portions 21 is made by press working sheet metal to have a substantially U-shaped cross section; the side frame main body portions 21 are arranged laterally opposite to each other. The side frame main body portion 21 is connected to the vertical pipe portion 13 with its upper portion holding the vertical pipe portion 13, and the lower portion of the side frame main body portion 21 protrudes frontward farther than the upper portion of the side frame main body portion 21 to form a bulging portion 22.

The pressure-receiving member 240 is a plate-like member made of plastic resin or the like and located between the right and left side frames 20 at the rear of the occupant. The pressure-receiving member 240 includes a pressure-receiving portion 241 disposed at a position corresponding to the center portion 251 of the seat back pad P2 and configured to support the back of the occupant via the center portion 251, and support portions 242 disposed at the rear of the side portions 252 and configured to support the side portions of the upper body of the occupant via the side portions 252.

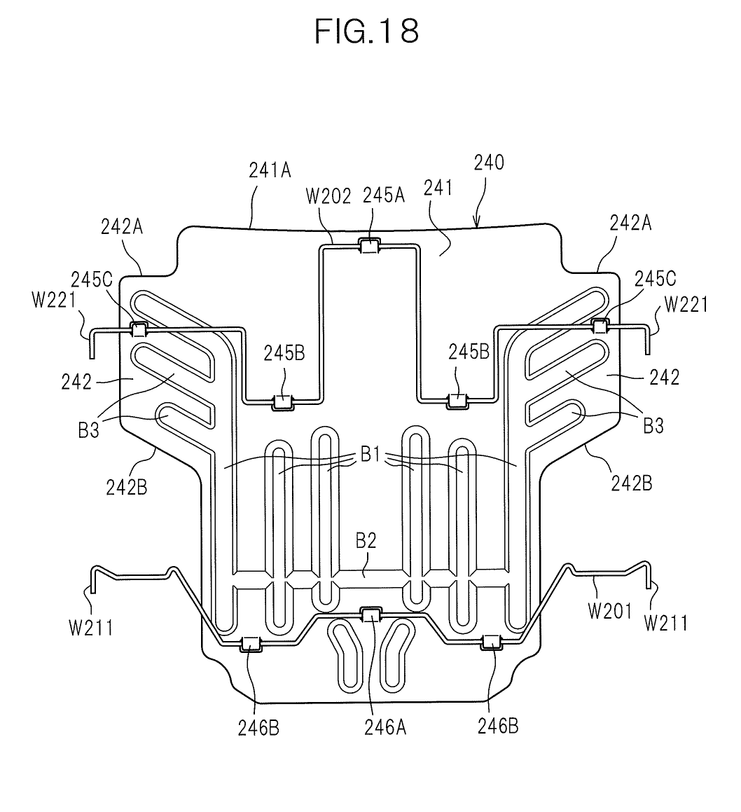

The pressure-receiving member 240 is supported by an upper connecting wire W202 and a lower connecting wire W201, which are examples of a connecting member, from the rear side thereof; both end portions W221, W211 of the upper connecting wire W202 and the lower connecting wire W201 (see FIG. 18) are connected to the right and left side frames 20.

The pressure-receiving portion 241 has a relatively large area in order to support the back of the occupant by its large surface (at least one third of the inner space of the frame-like seat back frame F2 is closed by the pressure-receiving portion 241).

The support portions 242 extend laterally outward and frontward from the lateral end portions of the pressure-receiving portion 241 and integrally formed with the pressure-receiving portion 241. To be more specific, the support portions 242 extend from the right and left end portions of the pressure-receiving portion 241 at a predetermined region below the armpits of the occupant (i.e., corresponding to the height of the side portions of the upper body).

As seen in FIG. 18, the pressure-receiving portion 241 is configured such that the width thereof at an upper portion above the support portions 242 is greater than the width thereof at a lower portion below the support portions 242. In other words, the width of the pressure-receiving portion increases with distance increasing toward the upper end thereof so as to fit the physique of the occupant; this configuration makes it possible to stably support the occupant.

The upper edge 241A of the pressure-receiving portion 241 extends substantially straight in the horizontal direction, and the upper edges 242A of the support portions 242 extend laterally outward from positions of the pressure-receiving portion 241 which are one step lower than the upper edge 241A. In other words, a stepped portion is formed between the upper edge 241A and the upper edges 242A.

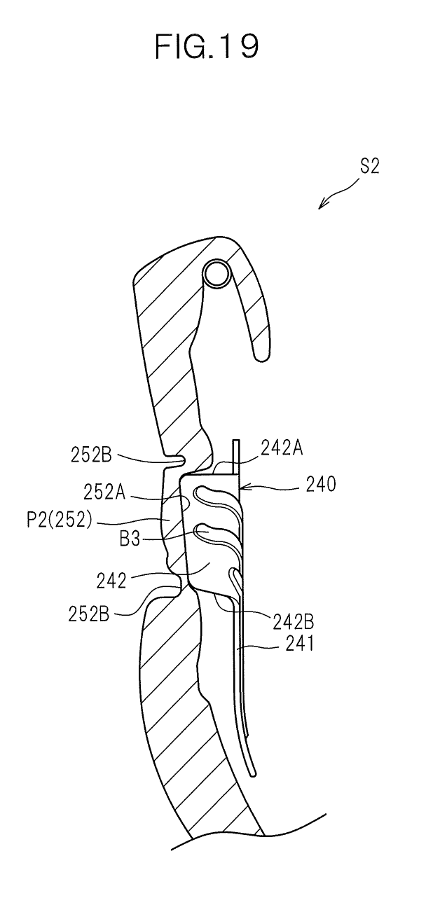

The lower edges 242B of the support portions 242 extend laterally outward and upward from the right and left end portions of the pressure-receiving portion 241 at a height position in the vicinity of the center thereof. As seen in FIG. 19, each of the support portions 242 is disposed to enter a recess portion 252A formed in the inner surface of the side portion 252 of the seat back pad P2. In other words, that portion of the side portion 252 which faces the support portion 242 has the recess portion 252A and is thinner than the upper and lower portions of the side portion 252, with the result that it is easily deformable when a large load is applied from the occupant. Further, groove portions 252B are provided in the front surface of the seat back pad P2 at positions above and below the support portions 242, so that the seat back pad P2 is more easily deformable. As described above, since the side portions 252 are easily deformable at portions corresponding to the support portions 242, a load from the occupant is easily transmitted to the support portions 242. This deformability may disadvantageously result in the increased likelihood of interference between the support portions 242 and the seat back pad P2; however, since a relief portion is provided in each of the support portions 242 according to this embodiment, the interference between the seat back pad P2 and the support portions 242 can be efficiently suppressed.

As seen in FIG. 18, a plurality of bead portions are formed on the pressure-receiving portion 241; each of the bead portions protrudes rearward and is shaped to recess as viewed from the front side. These bead portions include a plurality of first bead portions B1 extending in the upper-lower direction, a second bead portion B2 extending horizontally to connect lower portions of the first bead portions B1, and three third bead portions B3 extending obliquely in a laterally outward and upward direction from the upper portion of each of two laterally outermost first bead portions B1. The third bead portions B3 at one side extend from the pressure-receiving portion 241 passing through the boundary between the pressure-receiving portion 241 and the support portion 242, and distal ends of the third bead portions B3 reach the vicinity of the right or the left end of the support portion 242.

A plurality of hook portions engageable with the upper connecting wire W202 or the lower connecting wire W201 are provided on the pressure-receiving member 240. To be more specific, engagement hooks for supporting the upper connecting wire W202 include a first engagement hook 245A located at an upper center portion of the pressure-receiving portion 241, two second engagement hooks 245B located laterally outward of the first engagement hook 245A at positions below the first engagement hook 245A, and two third engagement hooks 245C located laterally outward of the second engagement hooks 245B at portions of the support portions 242 and slightly above the second engagement hooks 245B. Further, engagement hooks for supporting the lower connecting wire W201 include a fourth engagement hook 246A located at a lower center portion of the pressure-receiving portion 241, and two fifth engagement hooks 246B located laterally outward of the fourth engagement hook 246A at positions slightly below the fourth engagement hook 246A.

Of these engagement hooks, each of the third engagement hooks 245C provided on the support portions 242 is positioned between third bead portions B3 which are adjacently arranged one above the other. This configuration makes it possible to suppress the thickness of the support portions 242 as compared to the configuration in which the engagement hooks are provided on the bead portions. Further, each of the third engagement hooks 245C is provided between the third bead portions B3 for enhancing the rigidity of the support portions 242; this configuration makes it possible to provide a stable support by the upper connecting wire W202.

The upper connecting wire W202 is bent upward and downward so as to be engageable with and pass through the first engagement hook 245A, the second engagement hooks 245B, and the third engagement hooks 245C. The upper connecting wire W202 is bent downward at both right and left end portions W221 thereof, and although not shown in the drawings, these end portions W221 are engaged with tubular engagement portions provided on the side frames 20.

The upper connecting wire W202 laterally passes through rear sides of the support portions 242 to support the support portions 242 from the rear sides thereof. Further, since the upper connecting wire W202 is engaged with the third engagement hooks 245C provided on the support portions 242, the upper connecting wire W202 is less likely to get out of position with respect to the support portions 242.

The lower connecting wire W201 is bent upward and downward so as to be engageable with and pass through the fourth engagement hook 246A and the fifth engagement hooks 246B. The lower connecting wire W201 has right and left end portions W211, which are engaged with lower ends of swinging mechanisms 260 (see FIG. 17). Each of the swinging mechanisms 260 is a conventional mechanism made of a link swingable in the front-rear directions and a spring; in the normal condition, the urging force of the spring causes the link to be positioned in the front position, but when a backward load equal to or greater than a predetermined value is applied to the lower end of the link, the swinging mechanism 260 operates to quickly swing rearward.

As seen in FIG. 17, a bracket 271 is provided at the right-side vertical pipe portion 13 of the side frame 20, and an air bag device 272 is fixed to the bracket 271 by a bolt 273 which is an example of a fixing member. The bolt 273 is disposed at a height position lower than the upper edge 241A of the pressure-receiving portion 241 and higher than the upper edges 242A of the support portions 242. For this reason, even though the head of the bolt 273 protrudes laterally inward, the interference thereof with the support portions 242 can be suppressed.

Operation and advantageous effects of the car seat S configured as described above will be described.

When the occupant is seated on the car seat S, a load applied from the upper body of the occupant leaning against the seat back S2 is normally supported by the pressure-receiving member 240 via the seat back pad P2 as shown in FIG. 16. The pressure-receiving member 240 slightly moves rearward by the elasticity of the upper connecting wire W202 and supports the upper body of the occupant with the help of the upper connecting wire W202. At this time, the back region of the upper body of the occupant is supported by the center portion 251 of the seat back pad P2, and the center portion 251 is then supported by the pressure-receiving portion 241 of the pressure-receiving member 240. Further, the side portions of the upper body of the occupant, particularly around portions from the shoulders to the arm pits, are supported by the side portions 252 of the seat back pad P2, and the side portions 252 are then supported by the support portions 242 located at the rear of the side portions 252. The support portions 242 are configured such that the upper edges 242A thereof are located lower than the upper edge 241A of the pressure-receiving portion 241 to thereby form relief portions; with this configuration, the occupant is less likely to experience an uncomfortable contact feeling at the upper corner portions of the support portions 242 and thus a comfortable seating feeling can be provided.

Further, since a stepped portion is formed between the upper edge 242A of each of the support portions 242 and the upper edge 241A of the pressure-receiving portion 241, the support portions 242 are easily deformable at proximal portions where the support portions 242 extend from the pressure-receiving portion 241, so that a soft seating feeling can be obtained. It is to be noted that the pressure-receiving member 240 according to this embodiment includes the third bead portions B3 provided to extend over the pressure-receiving portion 241 and the support portions 242 and protruding rearward, and the third bead portions B3 extend obliquely in laterally outward and upward directions; this configuration can compensate the rigidity of the support portions reduced due to formation of the relief portions, and an appropriate support feeling for the upper body of the occupant can be obtained.

Further, the support portions 242 includes the third engagement hooks 245C as an example of an engagement hook engageable with the upper connecting wire W202, and the upper connecting wire W202 is engaged with the third engagement hooks 245C; therefore, the upper connecting wire W202 and the support portions 242 are held together and less likely to be shifted from each other, with the result that abnormal noise resulting from vibration is not likely to occur.

When a backward movement load occurs in the occupant, such as in the case of a rear-end collision of the vehicle, the upper body of the occupant is hardly pressed against the seat back pad P2. At this time, the load applied to the seat back pad P2 is transmitted not only to the pressure-receiving portion 241 via the center portion 251 but also to the support portions 242 via the side portions 252. The pressure-receiving member 240 receives the load by the pressure-receiving portion 241 and the support portions 242, and then moves rearward while allowing the swinging mechanisms 260 to swing rearward. Accordingly, while the pressure-receiving member 240 efficiently receives the load from the occupant, the occupant can be caused to quickly sink into the seat back S2. In the car seat S according to this embodiment, since the upper connecting wire W202 passes through the rear sides of the support portions 242, when the support portions 242 are pressed rearward by the load applied from the side portions of the upper body of the occupant, the load can be transmitted to the upper connecting wire W202 via the support portions 242; therefore, the occupant can be caused to quickly sink into the seat back S2.

At this time, although the support portions 242 are disposed to enter the corresponding recess portions 252A of the side portions 252 as shown in FIG. 19, providing the relief portions makes it possible to suppress undesirable interference between the support portions 242 and the seat back pad P2. Especially, in the seat back pad of a normal-type car seat, since the amount of frontward protrusion of the side portions 252 is smaller than that in the sport type car seat, the interference with the seat back pad P2 is likely to occur; however, according to this embodiment, providing the relief portions at the support portions 242 makes it possible to suppress undesirable interference.

In this instance, since the third engagement hooks 245C are engaged with the upper connecting wire W202, the upper connecting wire W202 and the support portions 242 are held together and less likely to be shifted from each other; therefore, when a large load is applied from the support portions 242 to the upper connecting wire W202, the load can be efficiently transmitted to the upper connecting wire W202.

Although embodiments of the present invention have been described, the present invention is not limited to the above-described embodiments; modifications and changes may be made to any of the specific configurations where necessary.

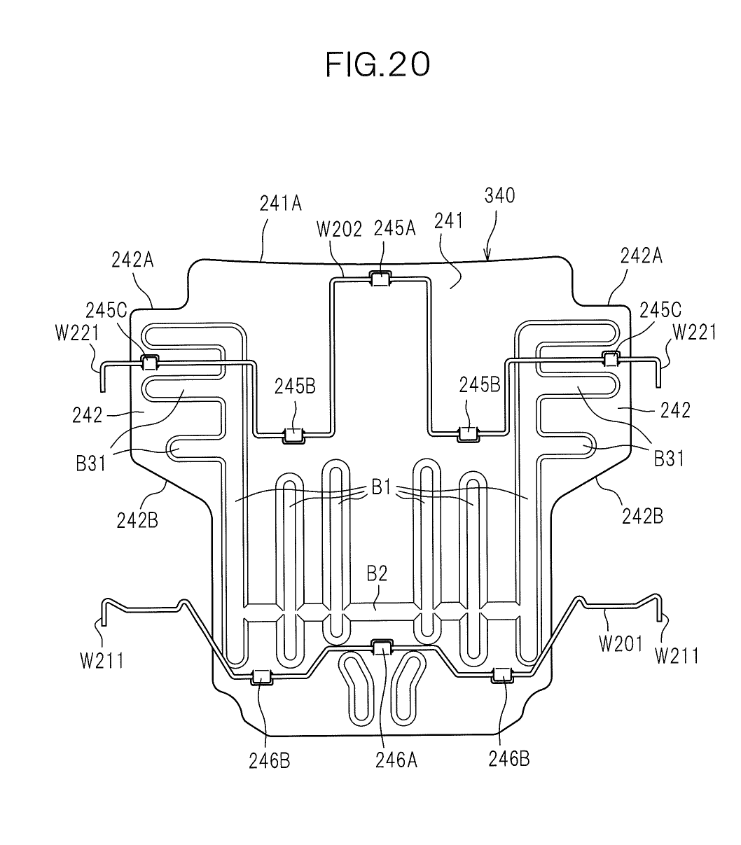

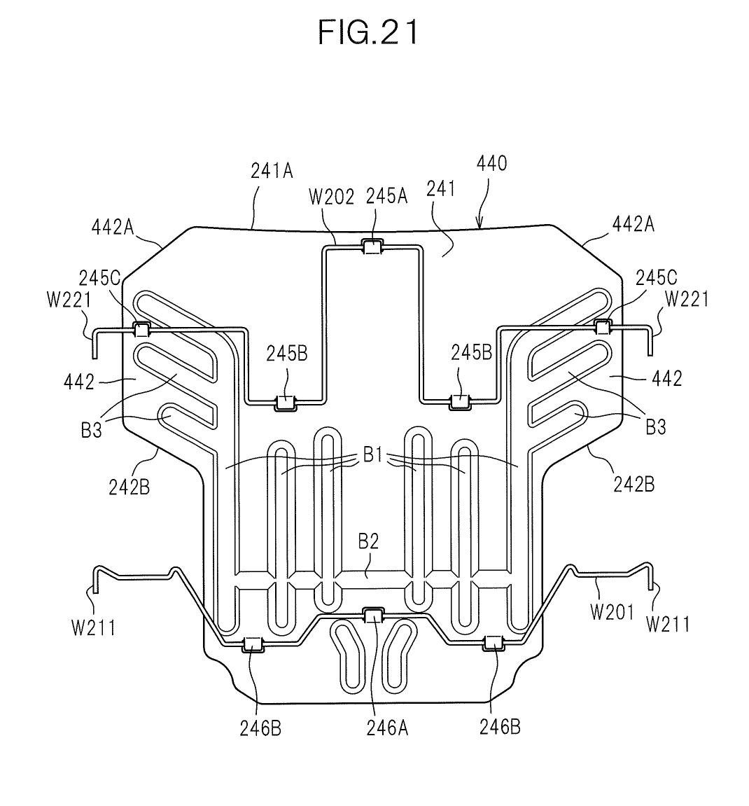

For example, as with a pressure-receiving member 340 according to the first modified embodiment shown in FIG. 20, the third bead portions B31 may be formed to extend horizontally instead of extending obliquely in laterally outward and upward directions. Further, as with a pressure-receiving member 440 according to the second modified embodiment shown in FIG. 21, instead of providing stepped portions between the upper edge 241A of the pressure-receiving portion 241 and the upper edges 442A of the support portions 442, the upper edges 442A of the support portions 442 may continue from the right and left ends of the upper edge 241A and slant such that the height of the upper edges 442 gradually lowers toward the laterally outer sides. In the case where the upper edges 442A gradually lowers toward the laterally outer sides thereof, it is preferable that the fixing member for fixing the air bag device 272 to the side frame 20 is disposed at a position lower than the upper edge 241A of the pressure-receiving portion 241 and higher than the lowest ends (i.e., both lateral ends) of the upper edges 442A of the support portions 442.

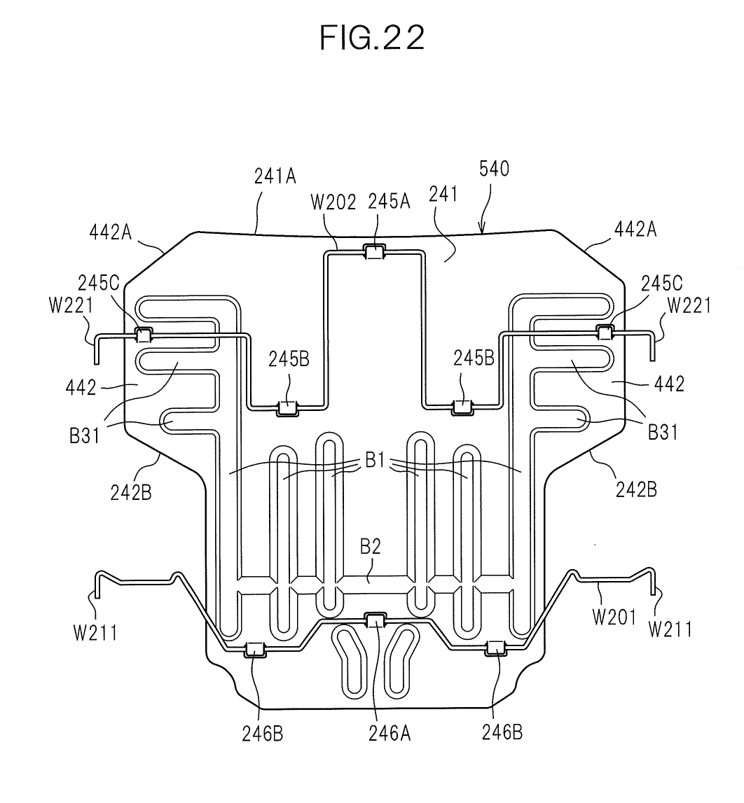

Further, although not shown in the drawings, as an intermediate configuration between the embodiment shown in FIG. 21 and the embodiment shown in FIG. 18, each of the upper edges 442A may be curved to have a downwardly-protruding curve shape (arc shape and the like). Further, as with a pressure-receiving member 540 according to the third modified embodiment shown in FIG. 22, the third bead portions B31 as shown in FIG. 20 and the upper edges 442A as shown in FIG. 21 may be combined together.

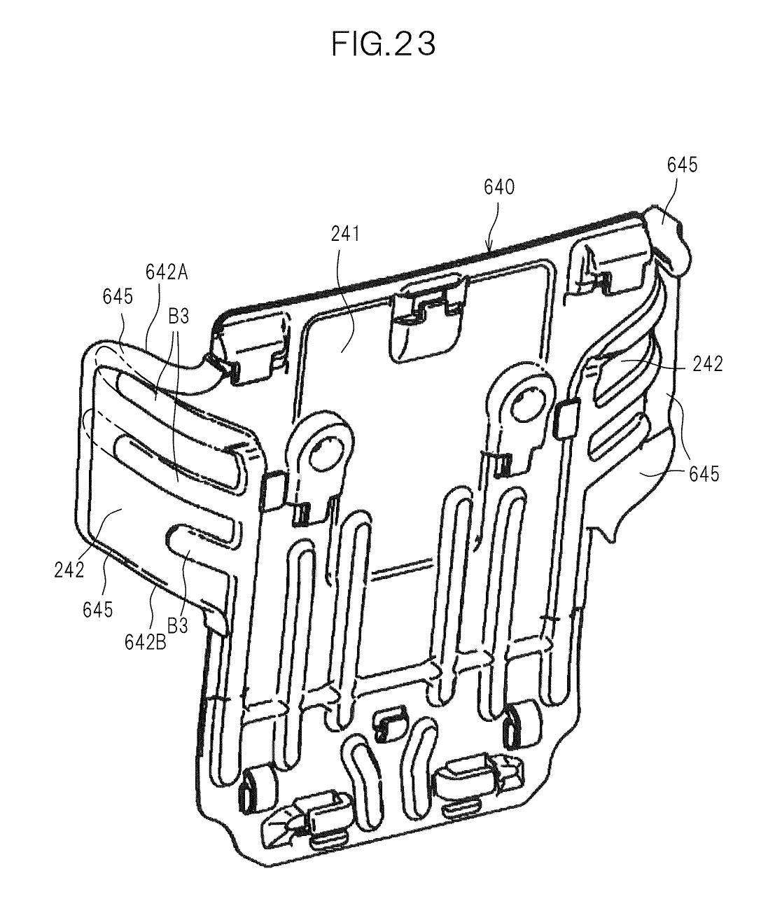

Further, in order to reinforce the support portions 242, as with a pressure-receiving member 640 according to the fourth modified embodiment shown in FIG. 23, edges of each of the support portions 242 from the upper edge 642A to the lower edge 642B may be bent rearward to provide a flange-shaped reinforcement portion 645. With this configuration, the reinforcement portion 645 can compensate the rigidity of the support portion 242 reduced due to formation of the relief portion to enhance the rigidity; therefore, a firm support feeling can be provided to the car seat S. It is to be noted that the reinforcement portion 645 may be provided at least at a portion of the upper edge 642A adjacent to the relief portion.

In the embodiment shown in FIG. 23 where the reinforcement portion 645 is provided at each of the support portions 242, the third bead portions B3 may extend to the reinforcement portion 645 as shown by chain double-dashed lines. With this configuration, the rigidity of the support portions 242 can be further enhanced, so that a more firm support feeling can be provided to the car seat S.

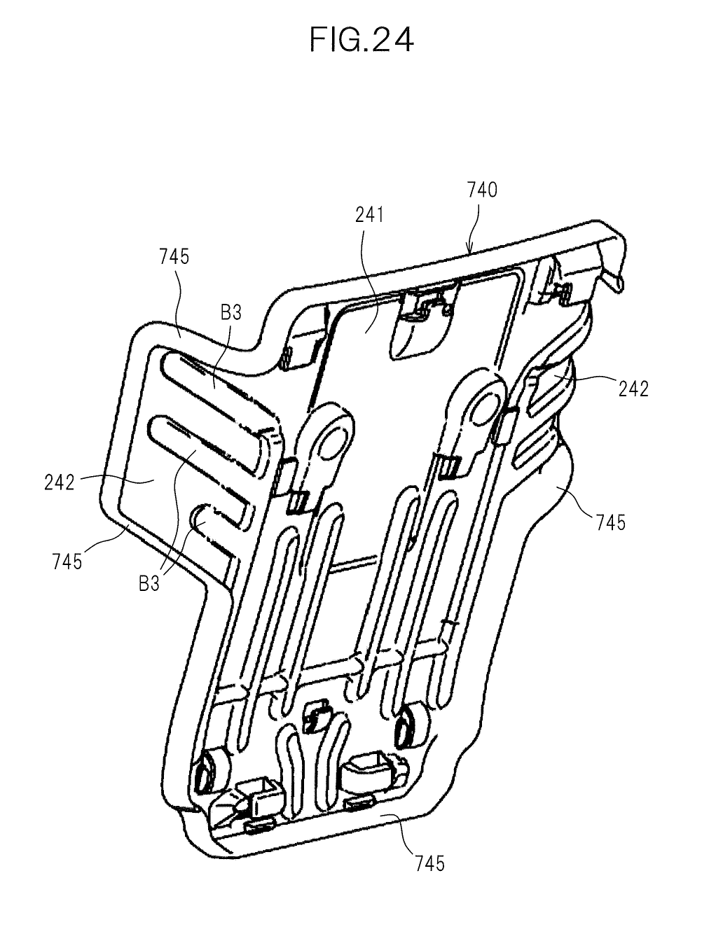

Further, as with a pressure-receiving member 740 according to the fifth modified embodiment shown in FIG. 24, flange-shaped reinforcement portions 745 may be provided at all the perimeters of the pressure-receiving member 740, that is, at all the edges of the pressure-receiving portion 241 and the support portions 242. According to this embodiment, the rigidity of the entire pressure-receiving member 240 can be enhanced, with the result that a firm and rigid seating feeling can be provided, for example, to a sport type car seat.

The above reinforcement portions 645, 745 are formed by bending the edges rearward into flange-shaped portions; however, these reinforcement portions may be formed by beads or thickened portions.

In the above embodiment, the bolt 273 has been exemplified as an example of the fixing member; however, the fixing member may be a nut, a clip for securing an interior part of the car, or a rivet.

Specific configurations of the seat frame F (seat cushion frame F1 and seat back frame F2) as shown in the above embodiments have been described by way of example only, and the present invention is not limited to this configuration shown in the above embodiments. For example, each of the right and left side frames 20 of the seat back frame F2 consists of the pipe-shaped vertical pipe portion 13 and the plate-like side frame main body portion 21 in the above embodiments. However, the present invention is not limited to this configuration; for example, each of the side frames may consist of the pipe-shaped frame only or the plate-like frame only.

In the above embodiment, the car seat S used in an automobile is illustrated as an example of a vehicle seat. However, the present invention is not limited to the car seat and applicable to other vehicle seat, such as a seat for marine vessel and a seat for aircraft.

1-30. (canceled)

31. A vehicle seat comprising a seat cushion and a seat back,
wherein the seat back includes:
a seat back frame comprising right and left side frames constituting right and left frames of the seat back;
a pressure-receiving portion located between the right and left side frames at a rear of an occupant and configured to be movable rearward relative to the right and left side frames; and
support portions extending laterally outward from right, and left end portions of the pressure-receiving portion and configured to support side portions of an upper body of the occupant in the seat back,
wherein the support portions extend frontward relative to the pressure-receiving portion, and
wherein each of the support portions includes a bead portion.

32. The vehicle seat according to claim 31, wherein the bead portion protrudes rearward.

33. The vehicle seat according to claim 31, wherein the bead portion extends obliquely in a laterally outward and upward direction.

34. The vehicle seat according to claim 31, wherein the support portions are integrally formed with the pressure-receiving portion, and
wherein the pressure-receiving portion includes bead portions, which are connected to the bead portions provided on the support portions.

35. The vehicle seat according to claim 34, wherein the bead portions provided on the pressure-receiving portion include bead portions extending in an upper-lower direction, and
wherein the bead portion provided on each of the support portions extends obliquely in a laterally outward and upward direction from the bead portions provided on the pressure-receiving portion and extending in the upper-lower direction.

36. The vehicle seat according to claim 31, wherein each of the support portions has an edge, and a reinforcement portion is provided at least at an upper portion of the edge of the support portion, and
wherein the bead portion extends to the reinforcement portion.

37. The vehicle seat according to claim 31, wherein the support portions are provided at positions at least corresponding to a height of a chest region of the occupant.

38. The vehicle seat according to claim 31, further comprising a first connecting wire extending laterally and configured to connect the pressure-receiving portion with the right and left side frames,
wherein the first connecting wire is disposed at a position corresponding to the height of a lumbar region of the occupant, passing through rear sides of the support portions.

39. The vehicle seat according to claim 38, wherein the first connecting wire has bent portions protruding in at least one of upper and lower directions at rear sides of the support portions.

40. The vehicle seat according to claim 31, wherein the support portions are provided at positions corresponding to a height of a lumbar region of the occupant and a height of a chest region of the occupant.

41. The vehicle seat according to claim 40, further comprising a second connecting wire extending laterally and configured to connect the pressure-receiving portion with the right and left side frames,
wherein the second connecting wire is disposed at a position corresponding to the height of the chest region of the occupant, passing through rear sides of the support portions.

42. The vehicle seat according to claim 41, wherein the second connecting wire has bent portions protruding in at least one of upper and lower directions at the rear sides of the support portions.

43. The vehicle seat according to claim 40, wherein the support portions provided at the positions corresponding to the height of the lumbar region of the occupant and the support portions provided above said support portions at the positions corresponding to the height of the chest region of the occupant are joined together.

44. The vehicle seat according to claim 31, wherein the pressure-receiving portion comprises reinforcement beads.

45. The vehicle seat according to claim 41, wherein when a backward movement load is not applied from the upper body of the occupant to the seat back, laterally outermost portions of the second connecting wire are located outward of the support portions.

46. The vehicle seat according to claim 31, wherein each of the support portions comprises:
a plate-like support portion main body configured to support a side portion of the upper body of the occupant;
an engagement claw extending from the support portion main body toward the pressure-receiving portion and configured to be engageable with an engagement hole formed in each of right and left ends of the pressure-receiving portion; and
a bead provided on the support portion main body and extending in a direction in which the engagement claw extends.

47. The vehicle seat according to claim 31, further comprising a seat back pad covering the seat back frame,
wherein a pressure-receiving member consisting of the pressure-receiving portion and the support portions is supported by the seat back frame in such a manner that when a backward movement load is applied from the upper body of the occupant to the seat back, the upper body of the occupant is allowed to sink into the seat back,
wherein the seat back pad comprises a center portion configured to face a back region of the upper body of the occupant, and right and left side portions provided at right and left sides of the center portion and each configured to protrude frontward farther than the center portion,
wherein the pressure-receiving member is located in the seat back at a position corresponding to the center portion, and the pressure-receiving portion is connected to the right and left side frames via a connecting member, and
wherein the support portions are disposed at rear sides of the side portions, and an upper edge of each of the support portions is lower than an upper edge of the pressure-receiving portion such that a stepped portion is provided between the upper edge of each of the support portions and the upper edge of the pressure-receiving portion.

48. The vehicle seat according to claim 47, wherein a reinforcement portion is provided at the upper edge of each of the support portions.

49. The vehicle seat according to claim 47, wherein the connecting member passes through rear sides of the support portions.

50. The vehicle seat according to claim 49, wherein each of the support portions includes an engagement hook engageable with the connecting member.

51. The vehicle seat according to claim 47, further comprising a fixing member for fixing an air bag device to one of the side frames, wherein the fixing member is disposed at a position higher than a lowest end of the upper edge of each of the support portions.
